(19) United States
(12) Patent Application Publication
(10) Pub. No.: US 2025/0260531 A1
(43) Pub. Date: Aug. 14, 2025

(54) SOUNDING REFERENCE SIGNAL ANTENNA SWITCH WITH THREE TRANSMIT CHAINS

(71) Applicant: QUALCOMM Incorporated, San Diego, CA (US)

(72) Inventors: Yi HUANG, San Diego, CA (US); Enoch Shiao-Kuang LU, San Diego, CA (US); Muhammad Sayed Khairy ABDELGHAFFAR, San Jose, CA (US); Peter GAAL, San Diego, CA (US); Jae Ho RYU, San Diego, CA (US)

(21) Appl. No.: 19/051,004

(22) Filed: Feb. 11, 2025

Related U.S. Application Data
(60) Provisional application No. 63/553,535, filed on Feb. 14, 2024.

(51) Int. Cl. H04L 5/00; H04B 7/06

(52) U.S. Cl. CPC H04L 5/0048; H04B 7/0608; H04B 7/0628

(57) ABSTRACT

Methods, systems, and devices for wireless communications are described. A user equipment (UE) may receive an indication of a set of sounding occasions that includes resources for sounding a total quantity of antennas using a set of transmit chains of the UE. The UE may transmit one or more sounding reference signals (SRSs) over a first quantity of antenna(s) via a first group of the set of transmit chains, the first quantity of antenna(s) is less than the total quantity of antennas, and the first group is any quantity of the set of transmit chains. The UE may transmit one or more SRSs over a second quantity of antenna(s) via a second group of the set of transmit chains, the second quantity of antenna(s) is less than the total quantity of antennas, and the second group is any quantity of the set of transmit chains.

### CROSS REFERENCE TO RELATED APPLICATIONS

This application claims the benefit of U.S. Provisional Patent Application No. 63/553,535, filed Feb. 14, 2024, which is hereby incorporated by reference, in its entirety and for all purposes

### INTRODUCTION

The following relates to wireless communications, including sounding reference signal antenna switch. Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be as user equipment (UE).

### SUMMARY

The described techniques relate to improved methods, systems, devices, and apparatuses that support sounding reference signal (SRS) antenna switch. For example, the described techniques provide for sounding procedures for a user equipment (UE) configured with three transmit chains. The described techniques may apply to UEs with other numbers of transmit chains, where the UE has fewer transmit chains than antennas to be sounded. For example, the UE may be configured with three transmit chains and four receive chains (3T4R), 3T6R, or 3T8R where each antenna (e.g., 4, 6, or 8 antennas) may be sounded using the three transmit chains. For example, the network may transmit or otherwise output to the UE an indication of a set of sounding occasions. The set of sounding occasions may include or otherwise identify resources for the UE to sound at least four antennas using three transmit chains of the UE. For example, the UE may transmit sounding signals over a first subset of the four (or more) antennas using a first subset of the three transmit chains during a first sounding occasion and transmit sounding signals over a second subset of the four (or more) antennas using a second subset of the three transmit chains during a second sounding occasion.

A method of wireless communication performed by a network entity is described. The method may include receiving an indication of a set of sounding occasions, the set of sounding occasions including resources for sounding a total quantity of antennas using a set of transmit chains of the network entity, transmitting one or more sounding reference signals (SRSs) over a first quantity of one or more antennas of the total quantity of antennas via a first group of the set of transmit chains during a first sounding occasion in the set of sounding occasions, where the first quantity of one or more antennas is less than the total quantity of antennas, and where the first group is any quantity of the set of transmit chains, and transmitting one or more SRSs over a second quantity of one or more antennas of the total quantity of antennas via a second group of the set of transmit chains during a second sounding occasion in the set of sounding occasions, where the second quantity of one or more antennas is less than the total quantity of antennas, and where the second group is any quantity of the set of transmit chains, and where the first quantity of one or more antennas and the second quantity of one or more antennas are different quantities that collectively include the total quantity of antennas.

A network entity for wireless communication is described. The network entity may include a processing system configured to receive an indication of a set of sounding occasions, the set of sounding occasions including resources for sounding a total quantity of antennas using a set of transmit chains of the network entity, transmit one or more SRSs over a first quantity of one or more antennas of the total quantity of antennas via a first group of the set of transmit chains during a first sounding occasion in the set of sounding occasions, where the first quantity of one or more antennas is less than the total quantity of antennas, and where the first group is any quantity of the set of transmit chains, and transmit one or more SRSs over a second quantity of one or more antennas of the total quantity of antennas via a second group of the set of transmit chains during a second sounding occasion in the set of sounding occasions, where the second quantity of one or more antennas is less than the total quantity of antennas, and where the second group is any quantity of the set of transmit chains, and where the first quantity of one or more antennas and the second quantity of one or more antennas are different quantities that collectively include the total quantity of antennas.

Another network entity for wireless communication is described. The network entity may include means for receiving an indication of a set of sounding occasions, the set of sounding occasions including resources for sounding a total quantity of antennas using a set of transmit chains of the network entity, means for transmitting one or more SRSs over a first quantity of one or more antennas of the total quantity of antennas via a first group of the set of transmit chains during a first sounding occasion in the set of sounding occasions, where the first quantity of one or more antennas is less than the total quantity of antennas, and where the first group is any quantity of the set of transmit chains, and means for transmitting one or more SRSs over a second quantity of one or more antennas of the total quantity of antennas via a second group of the set of transmit chains during a second sounding occasion in the set of sounding occasions, where the second quantity of one or more antennas is less than the total quantity of antennas, and where the second group is any quantity of the set of transmit chains, and where the first quantity of one or more antennas and the second quantity of one or more antennas are different quantities that collectively include the total quantity of antennas.

A non-transitory computer-readable medium having code for wireless communication stored thereon is described. The code, when executed by a network entity, causes the network entity to receive an indication of a set of sounding occasions, the set of sounding occasions including resources for sounding a total quantity of antennas using a set of transmit chains of the network entity, transmit one or more SRSs over a first quantity of one or more antennas of the total quantity of antennas via a first group of the set of transmit chains during a first sounding occasion in the set of sounding occasions, where the first quantity of one or more antennas is less than the total quantity of antennas, and where the first group is any quantity of the set of transmit chains, and transmit one or more SRSs over a second quantity of one or more antennas of the total quantity of antennas via a second group of the set of transmit chains during a second sounding occasion in the set of sounding occasions, where the second quantity of one or more antennas is less than the total quantity of antennas, and where the second group is any quantity of the set of transmit chains, and where the first quantity of one or more antennas and the second quantity of one or more antennas are different quantities that collectively include the total quantity of antennas.

In some examples of the method, network entities, and non-transitory computer-readable medium described herein, the set of transmit chains includes three transmit chains and the total quantity of antennas includes at least four antennas.

In some examples of the method, network entities, and non-transitory computer-readable medium described herein, the first quantity of one or more antennas excludes the one or more antennas of the second quantity of one or more antennas and the second quantity of one or more antennas excludes the one or more antennas of the first quantity of one or more antennas.

In some examples of the method, network entities, and non-transitory computer-readable medium described herein, the total quantity of antennas may be four antennas, the first quantity of one or more antennas may be three of the four antennas and the first group may be all of the three transmit chains, and the second quantity of one or more antennas may be one of the four antennas and the second group may be one of the three transmit chains.

In some examples of the method, network entities, and non-transitory computer-readable medium described herein, the first sounding occasion may be before the second sounding occasion.

In some examples of the method, network entities, and non-transitory computer-readable medium described herein, the second sounding occasion may be before the first sounding occasion.

In some examples of the method, network entities, and non-transitory computer-readable medium described herein, the resources include a four-port SRS configuration for application during transmission of the one or more SRSs via the first group and a one-port SRS configuration for application during transmission of the one or more SRSs via the second group.

In some examples of the method, network entities, and non-transitory computer-readable medium described herein, the resources include a three-port SRS configuration for application during transmission of the one or more SRSs via the first group and a one-port SRS configuration for application during transmission of the one or more SRSs via the second group.

Some examples of the method, network entities, and non-transitory computer-readable medium described herein may further include operations, features, means, or instructions for transmitting one or more SRSs over a third quantity of one or more antennas of the total quantity of antennas via a third group of the three transmit chains during a third sounding occasion in the set of sounding occasions, where the third quantity of one or more antennas excludes the one or more antennas of the first quantity of one or more antennas and of the second quantity of one or more antennas, and where the third group may be any quantity of the three transmit chains.

In some examples of the method, network entities, and non-transitory computer-readable medium described herein, the total quantity of antennas may be eight antennas, the first quantity of one or more antennas may be three of the eight antennas and the first group may be all of the three transmit chains, the second quantity of one or more antennas may be three of the eight antennas and the second group may be all of the three transmit chains, and the third quantity of one or more antennas may be two of the eight antennas and the third group may be two of the three transmit chains.

In some examples of the method, network entities, and non-transitory computer-readable medium described herein, the first sounding occasion and the second sounding occasion may be before the third sounding occasion.

In some examples of the method, network entities, and non-transitory computer-readable medium described herein, the first sounding occasion may be before the third sounding occasion and the third sounding occasion may be before the second sounding occasion.

In some examples of the method, network entities, and non-transitory computer-readable medium described herein, the third sounding occasion may be before the first sounding occasion and may be before the second sounding occasion.

In some examples of the method, network entities, and non-transitory computer-readable medium described herein, the resources include a four-port SRS configuration for application during transmission of the one or more SRSs via the first group and via the second group and a two-port SRS configuration for application during transmission of the one or more SRSs via the third group.

In some examples of the method, network entities, and non-transitory computer-readable medium described herein, the resources include a three-port SRS configuration for application during transmission of the one or more SRSs via the first group and via the second group and a two-port SRS configuration for application during transmission of the one or more SRSs via the third group.

In some examples of the method, network entities, and non-transitory computer-readable medium described herein, the SRSs transmitted during the first sounding occasion and the second sounding occasion may be transmitted at different transmit power levels.

In some examples of the method, network entities, and non-transitory computer-readable medium described herein, the network entity includes a user equipment (UE).

In some examples of the method, network entities, and non-transitory computer-readable medium described herein, a first number of transmit chains in the set of transmit chains may be a smaller number than a second number of antennas in the total quantity of antennas.

A method of wireless communication performed by a network entity is described. The method may include receiving an indication of a set of sounding occasions, the set of sounding occasions including resources for sounding a total quantity of antennas using three transmit chains of the network entity, where the total quantity of antennas includes at least four antennas, transmitting one or more SRSs over a first quantity of one or more antennas of the total quantity of antennas via the three transmit chains during a first sounding occasion in the set of sounding occasions, where the first quantity of one or more antennas is less than the total quantity of antennas, and transmitting one or more SRSs over a second quantity of one or more antennas of the total quantity of antennas via the three transmit chains during a second sounding occasion in the set of sounding occasions, where the second quantity of one or more antennas is less than all of the total quantity of antennas, and where the first quantity of one or more antennas and the second quantity of antennas each include a same quantity of antennas that collectively include the at least four antennas.

A network entity for wireless communication is described. The network entity may include a processing system configured to receive an indication of a set of sounding occasions, the set of sounding occasions including resources for sounding a total quantity of antennas using three transmit chains of the network entity, where the total quantity of antennas includes at least four antennas, transmit one or more SRSs over a first quantity of one or more antennas of the total quantity of antennas via the three transmit chains during a first sounding occasion in the set of sounding occasions, where the first quantity of one or more antennas is less than the total quantity of antennas, and transmit one or more SRSs over a second quantity of one or more antennas of the total quantity of antennas via the three transmit chains during a second sounding occasion in the set of sounding occasions, where the second quantity of one or more antennas is less than all of the total quantity of antennas, and where the first quantity of one or more antennas and the second quantity of antennas each include a same quantity of antennas that collectively include the at least four antennas.

Another network entity for wireless communication is described. The network entity may include means for receiving an indication of a set of sounding occasions, the set of sounding occasions including resources for sounding a total quantity of antennas using three transmit chains of the network entity, where the total quantity of antennas includes at least four antennas, means for transmitting one or more SRSs over a first quantity of one or more antennas of the total quantity of antennas via the three transmit chains during a first sounding occasion in the set of sounding occasions, where the first quantity of one or more antennas is less than the total quantity of antennas, and means for transmitting one or more SRSs over a second quantity of one or more antennas of the total quantity of antennas via the three transmit chains during a second sounding occasion in the set of sounding occasions, where the second quantity of one or more antennas is less than all of the total quantity of antennas, and where the first quantity of one or more antennas and the second quantity of antennas each include a same quantity of antennas that collectively include the at least four antennas.

A non-transitory computer-readable medium having code for wireless communication stored thereon is described. The code, when executed by a network entity, causes the network entity to receive an indication of a set of sounding occasions, the set of sounding occasions including resources for sounding a total quantity of antennas using three transmit chains of the network entity, where the total quantity of antennas includes at least four antennas, transmit one or more SRSs over a first quantity of one or more antennas of the total quantity of antennas via the three transmit chains during a first sounding occasion in the set of sounding occasions, where the first quantity of one or more antennas is less than the total quantity of antennas, and transmit one or more SRSs over a second quantity of one or more antennas of the total quantity of antennas via the three transmit chains during a second sounding occasion in the set of sounding occasions, where the second quantity of one or more antennas is less than all of the total quantity of antennas, and where the first quantity of one or more antennas and the second quantity of antennas each include a same quantity of antennas that collectively include the at least four antennas.

In some examples of the method, network entities, and non-transitory computer-readable medium described herein, the second quantity of one or more antennas includes at least one antenna from the first quantity of one or more antennas.

In some examples of the method, network entities, and non-transitory computer-readable medium described herein, the total quantity of antennas may be four antennas and a quantity of antennas included in each of the first quantity of one or more antennas and the second quantity of one or more antennas may be three.

In some examples of the method, network entities, and non-transitory computer-readable medium described herein, the first quantity of one or more antennas includes a first antenna, a second antenna, and a third antenna and the second quantity of one or more antennas includes a fourth antenna, the first antenna, and the second antenna.

Some examples of the method, network entities, and non-transitory computer-readable medium described herein may further include operations, features, means, or instructions for transmitting one or more SRSs over a third quantity of one or more antennas of the total quantity of antennas via a third group of the three transmit chains during a third sounding occasion in the set of sounding occasions.

In some examples of the method, network entities, and non-transitory computer-readable medium described herein, the total quantity of antennas may be eight antennas, a quantity of antennas included in each of the first quantity of one or more antennas, the second quantity of one or more antennas, and the third quantity of one or more antennas may be three, and the first quantity of one or more antennas, the second quantity of one or more antennas, and the third quantity of one or more antennas collectively include all of the eight antennas.

In some examples of the method, network entities, and non-transitory computer-readable medium described herein, the first quantity of one or more antennas includes a first antenna, a second antenna, and a third antennas, the second quantity of one or more antennas includes a fourth antenna, a fifth antenna, and a sixth antenna, and the third quantity of one or more antennas includes a seventh antenna, an eighth antenna, and the first antenna.

In some examples of the method, network entities, and non-transitory computer-readable medium described herein, the resources include a four-port SRS configuration for application during transmission of the one or more SRSs via the three transmit chains.

In some examples of the method, network entities, and non-transitory computer-readable medium described herein, the resources include a three-port SRS configuration for application during transmission of the one or more SRSs via the three transmit chains.

Some examples of the method, network entities, and non-transitory computer-readable medium described herein may further include operations, features, means, or instructions for receiving information identifying an overlap in specific antennas included in each quantity of one or more antennas.

In some examples of the method, network entities, and non-transitory computer-readable medium described herein, the network entity includes a UE.

A method of wireless communication performed by a network entity is described. The method may include transmitting, to a UE, an indication of a set of sounding occasions, the set of sounding occasions including resources for sounding a total quantity of antennas using a set of transmit chains of the UE, receiving, from the UE, one or more SRSs over a first quantity of one or more antennas of the total quantity of antennas via a first group of the set of transmit chains during a first sounding occasion in the set of sounding occasions, where the first quantity of one or more antennas is less than the total quantity of antennas and the first group is any quantity of the set of transmit chains, and receiving, from the UE, one or more SRSs over a second quantity of one or more antennas of the total quantity of antennas via a second group of the set of transmit chains during a second sounding occasion in the set of sounding occasions, where the second quantity of one or more antennas is less than the total quantity of antennas and the second group is any quantity of the set of transmit chains, and where the first quantity of one or more antennas and the second quantity of one or more antennas are different quantities that collectively include the total quantity of antennas.

A network entity for wireless communication is described. The network entity may include processing system configured to transmit, to a UE, an indication of a set of sounding occasions, the set of sounding occasions including resources for sounding a total quantity of antennas using a set of transmit chains of the UE, receive, from the UE, one or more SRSs over a first quantity of one or more antennas of the total quantity of antennas via a first group of the set of transmit chains during a first sounding occasion in the set of sounding occasions, where the first quantity of one or more antennas is less than the total quantity of antennas and the first group is any quantity of the set of transmit chains, and receive, from the UE, one or more SRSs over a second quantity of one or more antennas of the total quantity of antennas via a second group of the set of transmit chains during a second sounding occasion in the set of sounding occasions, where the second quantity of one or more antennas is less than the total quantity of antennas and the second group is any quantity of the set of transmit chains, and where the first quantity of one or more antennas and the second quantity of one or more antennas are different quantities that collectively include the total quantity of antennas.

Another network entity for wireless communication is described. The network entity may include means for transmitting, to a UE, an indication of a set of sounding occasions, the set of sounding occasions including resources for sounding a total quantity of antennas using a set of transmit chains of the UE, means for receiving, from the UE, one or more SRSs over a first quantity of one or more antennas of the total quantity of antennas via a first group of the set of transmit chains during a first sounding occasion in the set of sounding occasions, where the first quantity of one or more antennas is less than the total quantity of antennas and the first group is any quantity of the set of transmit chains, and means for receiving, from the UE, one or more SRSs over a second quantity of one or more antennas of the total quantity of antennas via a second group of the set of transmit chains during a second sounding occasion in the set of sounding occasions, where the second quantity of one or more antennas is less than the total quantity of antennas and the second group is any quantity of the set of transmit chains, and where the first quantity of one or more antennas and the second quantity of one or more antennas are different quantities that collectively include the total quantity of antennas.

A non-transitory computer-readable medium having code for wireless communication stored thereon is described. The code, when executed by a a network entity, causes the network entity to transmit, to a UE, an indication of a set of sounding occasions, the set of sounding occasions including resources for sounding a total quantity of antennas using a set of transmit chains of the UE, receive, from the UE, one or more SRSs over a first quantity of one or more antennas of the total quantity of antennas via a first group of the set of transmit chains during a first sounding occasion in the set of sounding occasions, where the first quantity of one or more antennas is less than the total quantity of antennas and the first group is any quantity of the set of transmit chains, and receive, from the UE, one or more SRSs over a second quantity of one or more antennas of the total quantity of antennas via a second group of the set of transmit chains during a second sounding occasion in the set of sounding occasions, where the second quantity of one or more antennas is less than the total quantity of antennas and the second group is any quantity of the set of transmit chains, and where the first quantity of one or more antennas and the second quantity of one or more antennas are different quantities that collectively include the total quantity of antennas.

In some examples of the method, network entities, and non-transitory computer-readable medium described herein, the set of transmit chains includes three transmit chains and the total quantity of antennas includes at least four antennas.

In some examples of the method, network entities, and non-transitory computer-readable medium described herein, the first quantity of one or more antennas excludes the one or more antennas of the second quantity of one or more antennas and the second quantity of one or more antennas excludes the one or more antennas of the first quantity of one or more antennas.

In some examples of the method, network entities, and non-transitory computer-readable medium described herein, the total quantity of antennas may be four antennas, the first quantity of one or more antennas may be three of the four antennas and the first group may be all of the three transmit chains, and the second quantity of one or more antennas may be one of the four antennas and the second group may be one of the three transmit chains.

In some examples of the method, network entities, and non-transitory computer-readable medium described herein, the first sounding occasion may be before the second sounding occasion.

In some examples of the method, network entities, and non-transitory computer-readable medium described herein, the second sounding occasion may be before the first sounding occasion.

In some examples of the method, network entities, and non-transitory computer-readable medium described herein, the resources include a four-port SRS configuration for application during transmission of the one or more SRSs via the first group and a one-port SRS configuration for application during transmission of the one or more SRSs via the second group.

In some examples of the method, network entities, and non-transitory computer-readable medium described herein, the resources include a three-port SRS configuration for application during transmission of the one or more SRSs via the first group and a one-port SRS configuration for application during transmission of the one or more SRSs via the second group.

Some examples of the method, network entities, and non-transitory computer-readable medium described herein may further include operations, features, means, or instructions for receiving, from the UE, one or more SRSs over a third quantity of one or more antennas of the total quantity of antennas via a third group of the three transmit chains during a third sounding occasion in the set of sounding occasions, where the third quantity of one or more antennas excludes the one or more antennas of the first quantity of one or more antennas and of the second quantity of one or more antennas, and where the third group may be any quantity of the three transmit chains.

In some examples of the method, network entities, and non-transitory computer-readable medium described herein, the total quantity of antennas may be eight antennas, the first quantity of one or more antennas may be three of the eight antennas and the first group may be all of the three transmit chains, the second quantity of one or more antennas may be three of the eight antennas and the second group may be all of the three transmit chains, and the third quantity of one or more antennas may be two of the eight antennas and the third group may be two of the three transmit chains.

In some examples of the method, network entities, and non-transitory computer-readable medium described herein, the first sounding occasion and the second sounding occasion may be before the third sounding occasion.

In some examples of the method, network entities, and non-transitory computer-readable medium described herein, the first sounding occasion may be before the third sounding occasion and the third sounding occasion may be before the second sounding occasion.

In some examples of the method, network entities, and non-transitory computer-readable medium described herein, the third sounding occasion may be before the first sounding occasion and may be before the second sounding occasion.

In some examples of the method, network entities, and non-transitory computer-readable medium described herein, the resources include a four-port SRS configuration for application during transmission of the one or more SRSs via the first group and via the second group and a two-port SRS configuration for application during transmission of the one or more SRSs via the third group.

In some examples of the method, network entities, and non-transitory computer-readable medium described herein, the resources include a three-port SRS configuration for application during transmission of the one or more SRSs via the first group and via the second group and a two-port SRS configuration for application during transmission of the one or more SRSs via the third group.

In some examples of the method, network entities, and non-transitory computer-readable medium described herein, the SRSs transmitted during the first sounding occasion and the second sounding occasion may be transmitted by the UE at different transmit power levels.

In some examples of the method, network entities, and non-transitory computer-readable medium described herein, a first number of transmit chains in the set of transmit chains may be a smaller number than a second number of antennas in the total quantity of antennas.

A method of wireless communication performed by a network entity is described. The method may include transmitting, to a UE, an indication of a set of sounding occasions, the set of sounding occasions including resources for sounding a total quantity of antennas using three transmit chains of the UE, where the total quantity of antennas includes at least four antennas, receiving, from the UE, one or more SRSs over a first quantity of one or more antennas of the total quantity of antennas via the three transmit chains during a first sounding occasion in the set of sounding occasions, where the first quantity of one or more antennas is less than the total quantity of antennas, and receiving, from the UE, one or more SRSs over a second quantity of one or more antennas of the total quantity of antennas via the three transmit chains during a second sounding occasion in the set of sounding occasions, where the second quantity of one or more antennas is less than the total quantity of antennas, and where the first quantity of one or more antennas and the second quantity of one or more antennas each include a same quantity of antennas that collectively include the at least four antennas.

A network entity for wireless communication is described. The network entity may include processing system configured to transmit, to a UE, an indication of a set of sounding occasions, the set of sounding occasions including resources for sounding a total quantity of antennas using three transmit chains of the UE, where the total quantity of antennas includes at least four antennas, receive, from the UE, one or more SRSs over a first quantity of one or more antennas of the total quantity of antennas via the three transmit chains during a first sounding occasion in the set of sounding occasions, where the first quantity of one or more antennas is less than the total quantity of antennas, and receive, from the UE, one or more SRSs over a second quantity of one or more antennas of the total quantity of antennas via the three transmit chains during a second sounding occasion in the set of sounding occasions, where the second quantity of one or more antennas is less than the total quantity of antennas, and where the first quantity of one or more antennas and the second quantity of one or more antennas each include a same quantity of antennas that collectively include the at least four antennas.

Another network entity for wireless communication is described. The network entity may include means for transmitting, to a UE, an indication of a set of sounding occasions, the set of sounding occasions including resources for sounding a total quantity of antennas using three transmit chains of the UE, where the total quantity of antennas includes at least four antennas, means for receiving, from the UE, one or more SRSs over a first quantity of one or more antennas of the total quantity of antennas via the three transmit chains during a first sounding occasion in the set of sounding occasions, where the first quantity of one or more antennas is less than the total quantity of antennas, and means for receiving, from the UE, one or more SRSs over a second quantity of one or more antennas of the total quantity of antennas via the three transmit chains during a second sounding occasion in the set of sounding occasions, where the second quantity of one or more antennas is less than the total quantity of antennas, and where the first quantity of one or more antennas and the second quantity of one or more antennas each include a same quantity of antennas that collectively include the at least four antennas.

A non-transitory computer-readable medium having code for wireless communication stored thereon is described. The code, when executed by a network entity, causes the network entity to transmit, to a UE, an indication of a set of sounding occasions, the set of sounding occasions including resources for sounding a total quantity of antennas using three transmit chains of the UE, where the total quantity of antennas includes at least four antennas, receive, from the UE, one or more SRSs over a first quantity of one or more antennas of the total quantity of antennas via the three transmit chains during a first sounding occasion in the set of sounding occasions, where the first quantity of one or more antennas is less than the total quantity of antennas, and receive, from the UE, one or more SRSs over a second quantity of one or more antennas of the total quantity of antennas via the three transmit chains during a second sounding occasion in the set of sounding occasions, where the second quantity of one or more antennas is less than the total quantity of antennas, and where the first quantity of one or more antennas and the second quantity of one or more antennas each include a same quantity of antennas that collectively include the at least four antennas.

In some examples of the method, network entities, and non-transitory computer-readable medium described herein, the second quantity of one or more antennas includes at least one antennas from the first quantity of one or more antennas.

In some examples of the method, network entities, and non-transitory computer-readable medium described herein, the total quantity of antennas includes four antennas and a quantity of antennas included in each of the first quantity of one or more antennas and the second quantity of one or more antennas t may be three.

In some examples of the method, network entities, and non-transitory computer-readable medium described herein, the first quantity of one or more antennas includes a first antenna, a second antenna, and a third antenna and the second quantity of one or more antennas includes a fourth antenna, the first antenna, and the second antenna.

Some examples of the method, network entities, and non-transitory computer-readable medium described herein may further include operations, features, means, or instructions for receiving, from the UE, one or more SRSs over a third quantity of one or more antennas of the total quantity of antennas via a third group of the three transmit chains during a third sounding occasion in the set of sounding occasions.

In some examples of the method, network entities, and non-transitory computer-readable medium described herein, the total quantity of antennas may be eight antennas, a quantity of antennas included in each of the first quantity of one or more antennas, the second quantity of one or more antennas, and the third quantity of one or more antennas may be three, and the first quantity of one or more antennas, the second quantity of one or more antennas, and the third quantity of one or more antennas collectively include all of the eight antennas.

In some examples of the method, network entities, and non-transitory computer-readable medium described herein, the first quantity of one or more antennas includes a first antenna, a second antenna, and a third antennas, the second quantity of one or more antennas includes a fourth antenna, a fifth antenna, and a sixth antenna, and the third quantity of one or more antennas includes a seventh antenna, an eighth antenna, and the first antenna.

In some examples of the method, network entities, and non-transitory computer-readable medium described herein, the resources include a four-port SRS configuration for application during transmission of the one or more SRSs via the three transmit chains.

In some examples of the method, network entities, and non-transitory computer-readable medium described herein, the resources include a three-port SRS configuration for application during transmission of the one or more SRSs via the three transmit chains.

Some examples of the method, network entities, and non-transitory computer-readable medium described herein may further include operations, features, means, or instructions for transmitting, to the UE, information identifying an overlap in specific antennas included in each quantity of one or more antennas.

### BRIEF DESCRIPTION OF THE DRAWINGS

FIG. 1 shows an example of a wireless communications system that supports sounding reference signal (SRS) antenna switch with three transmit chains in accordance with one or more aspects of the present disclosure.

FIG. 2 shows an example of a wireless communications system that supports SRS antenna switch with three transmit chains in accordance with one or more aspects of the present disclosure.

FIGS. 3A-3B show examples of a sounding configuration that supports SRS antenna switch with three transmit chains in accordance with one or more aspects of the present disclosure.

FIGS. 4A-4C show examples of a sounding configuration that supports SRS antenna switch with three transmit chains in accordance with one or more aspects of the present disclosure.

FIGS. 5A-5B show examples of a sounding configuration that supports SRS antenna switch with three transmit chains in accordance with one or more aspects of the present disclosure.

FIGS. 6 and 7 show block diagrams of devices that support SRS antenna switch with three transmit chains in accordance with one or more aspects of the present disclosure.

FIG. 8 shows a block diagram of a communications manager that supports SRS antenna switch with three transmit chains in accordance with one or more aspects of the present disclosure.

FIG. 9 shows a diagram of a system including a device that supports SRS antenna switch with three transmit chains in accordance with one or more aspects of the present disclosure.

FIGS. 10 and 11 show block diagrams of devices that support SRS antenna switch with three transmit chains in accordance with one or more aspects of the present disclosure.

FIG. 12 shows a block diagram of a communications manager that supports SRS antenna switch with three transmit chains in accordance with one or more aspects of the present disclosure.

FIG. 13 shows a diagram of a system including a device that supports SRS antenna switch with three transmit chains in accordance with one or more aspects of the present disclosure.

FIGS. 14 through 17 show flowcharts illustrating methods that support SRS antenna switch with three transmit chains in accordance with one or more aspects of the present disclosure.

### DETAILED DESCRIPTION

Wireless networks may use sounding procedures to determine channel characteristics of the wireless medium. A transmitter may transmit a signal (e.g., a sounding signal) at transmission parameters over the wireless medium. A receiver may measure the received signal and compare the measurement results to the transmission parameters to determine the channel performance metrics. The transmitter and receiver may use the channel performance metrics for various scheduling and allocation decisions for upcoming wireless communications. A user equipment (UE) may be configured with the same or a different number of transmit chains (x Tx chains) and receive chains (y Rx chains), with each receive chain having a dedicated or otherwise associated antenna. In some networks, the UE may be configured with 1T1R (e.g., x=1, y=1), 1T2R, 1T4R, 1T6R, 1T8R, 2T2R, 2T4R, 2T6R, 2T8R, 4T4R, 4T8R, or 8T8R. The sounding procedures for these UE are generally designed such that, in all modes, y can be divided by x. That is, the UE can conduct the xTyR antenna switching using y/x SRS occasions to sound x antenna in each of the SRS occasions. However, such networks may not support UE configured with 3TyR for such sounding procedures.

Accordingly, the described techniques provide for sounding procedures for a UE configured with three transmit chains. The described techniques may apply to UEs with other numbers of transmit chains, where the UE has fewer transmit chains than antennas to be sounded. For example, the UE may be configured with 3T4R, 3T6R, or 3T8R where each antenna (e.g., 4, 6, or 8 antennas) may be sounded using the three transmit chains. For example, the network may transmit or otherwise output to the UE an indication of a set of sounding occasions. The set of sounding occasions may include or otherwise identify resources for the UE to sound at least four antennas using three transmit chains of the UE. For example, the UE may transmit sounding signals over a first subset of the four (or more) antennas using a first subset of the three transmit chains during a first sounding occasion and transmit sounding signals over a second subset of the four (or more) antennas using a second subset of the three transmit chains during a second sounding occasion.

Aspects of the disclosure are initially described in the context of wireless communications systems. Aspects of the disclosure are further illustrated by and described with reference to apparatus diagrams, system diagrams, and flowcharts that relate to sounding reference signal antenna switch with three transmit chains.

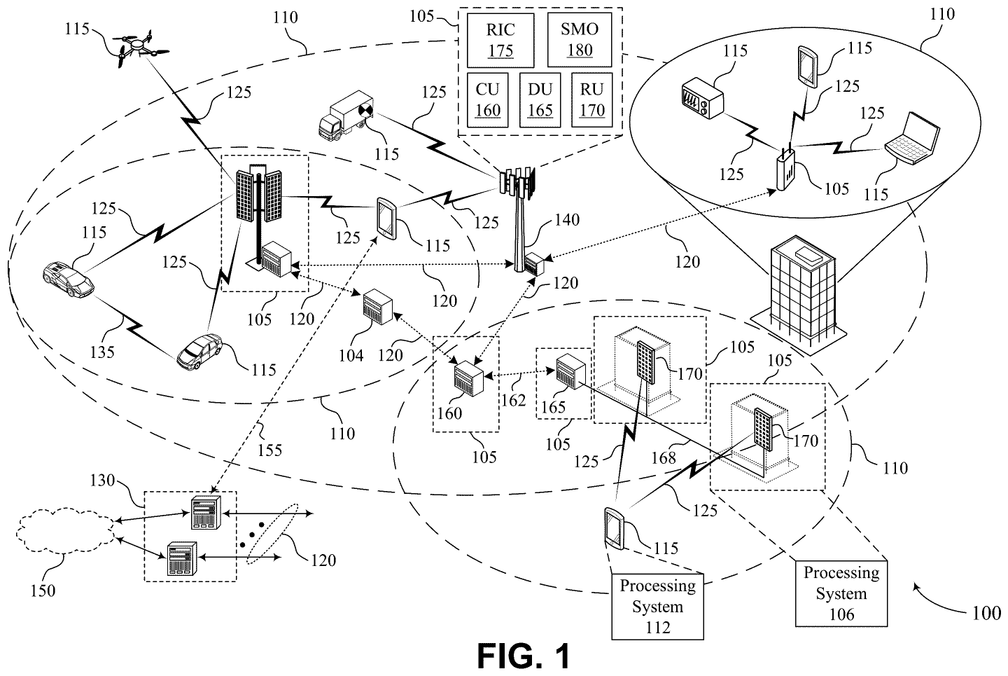

FIG. 1 shows an example of a wireless communications system 100 that supports SRS antenna switch with three transmit chains in accordance with one or more aspects of the present disclosure. The wireless communications system 100 may include one or more devices, such as one or more network devices (e.g., network entities 105), one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various aspects, a network entity 105 may be referred to as a network element, a mobility element, a radio access network (RAN) node, or network equipment, among other nomenclature. In some aspects, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these aspects. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these aspects.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some aspects, the first communication interface may be an interface configured to receive input information, and the information may be provided to the processing system. In some aspects, the second system interface may be configured to transmit information output from the chip or modem. The second communication interface may also obtain or receive input information, and the first communication interface may also output, transmit, or provide information.

In some aspects, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some aspects, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other aspects or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some aspects, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other aspects. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other aspects, which may be implemented in various objects such as appliances, vehicles, or meters, among other aspects.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other aspects, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some aspects, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some aspects, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other aspects.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area, such as the coverage area 110. In some aspects, coverage areas 110 (e.g., different coverage areas) associated with different technologies may overlap, but the coverage areas 110 (e.g., different coverage areas) may be supported by the same network entity (e.g., a network entity 105). In some other aspects, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some aspects, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some aspects, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Aspects of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some aspects, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to one or more of the UEs 115 in the group. In some aspects, a network entity 105 may facilitate the scheduling of resources for D2D communications. In some other aspects, D2D communications may be carried out between the UEs 115 without an involvement of a network entity 105.

In some systems, a D2D communication link 135 may be an example of a communication channel, such as a sidelink communication channel, between vehicles (e.g., UEs 115). In some aspects, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some aspects, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also as the centimeter band, or using an extremely high frequency (EHF) region of the spectrum (e.g., from 30 GHz to 300 GHz), also as the millimeter band. In some aspects, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some aspects, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other aspects.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some aspects, a device may support same-slot HARQ feedback, in which case the device may provide HARQ feedback in a specific slot for data received via a previous symbol in the slot. In some other aspects, the device may provide HARQ feedback in a subsequent slot, or according to some other time interval.

A UE 115 may receive an indication of a set of sounding occasions, the set of sounding occasions including resources for sounding a total quantity of antennas using a set of transmit chains of the network entity. The UE 115 may transmit one or more sounding reference signals (SRSs) over a first quantity of one or more antennas of the total quantity of antennas via a first group of the set of transmit chains during a first sounding occasion in the set of sounding occasions, wherein the first quantity of one or more antennas is less than the total quantity of antennas, and wherein the first group is any quantity of the set of transmit chains. The UE may transmit one or more SRSs over a second quantity of one or more antennas of the total quantity of antennas via a second group of the set of transmit chains during a second sounding occasion in the set of sounding occasions, wherein the second quantity of one or more antennas is less than the total quantity of antennas, and wherein the second group is any quantity of the set of transmit chains, and wherein the first quantity of one or more antennas and the second quantity of one or more antennas are different quantities that collectively include the total quantity of antennas.

A UE 115 may receive an indication of a set of sounding occasions, the set of sounding occasions including resources for sounding a total quantity of antennas using three transmit chains of the network entity, wherein the total quantity of antennas includes at least four antennas. The UE 115 may transmit one or more SRSs over a first quantity of one or more antennas of the total quantity of antennas via the three transmit chains during a first sounding occasion in the set of sounding occasions, wherein the first quantity of one or more antennas is less than the total quantity of antennas. The UE 115 may transmit one or more SRSs over a second quantity of one or more antennas of the total quantity of antennas via the three transmit chains during a second sounding occasion in the set of sounding occasions, wherein the second quantity of one or more antennas is less than all of the total quantity of antennas, and wherein the first quantity of one or more antennas and the second quantity of antennas each include a same quantity of antennas that collectively include the at least four antennas.

A network entity 105 may transmit, to a UE 115, an indication of a set of sounding occasions, the set of sounding occasions including resources for sounding a total quantity of antennas using a set of transmit chains of the UE 115. The network entity 105 may receive, from the UE 115, one or more SRSs over a first quantity of one or more antennas of the total quantity of antennas via a first group of the set of transmit chains during a first sounding occasion in the set of sounding occasions, wherein the first quantity of one or more antennas is less than the total quantity of antennas and the first group is any quantity of the set of transmit chains. The network entity 105 may receive, from the UE 115, one or more SRSs over a second quantity of one or more antennas of the total quantity of antennas via a second group of the set of transmit chains during a second sounding occasion in the set of sounding occasions, wherein the second quantity of one or more antennas is less than the total quantity of antennas and the second group is any quantity of the set of transmit chains, and wherein the first quantity of one or more antennas and the second quantity of one or more antennas are different quantities that collectively include the total quantity of antennas.

A network entity 105 may transmit, to a UE 115, an indication of a set of sounding occasions, the set of sounding occasions including resources for sounding a total quantity of antennas using three transmit chains of the UE, wherein the total quantity of antennas includes at least four antennas. The network entity 105 may receive, from the UE 115, one or more SRSs over a first quantity of one or more antennas of the total quantity of antennas via the three transmit chains during a first sounding occasion in the set of sounding occasions, wherein the first quantity of one or more antennas is less than the total quantity of antennas. The network entity 105 may receive, from the UE 115, one or more SRSs over a second quantity of one or more antennas of the total quantity of antennas via the three transmit chains during a second sounding occasion in the set of sounding occasions, wherein the second quantity of one or more antennas is less than the total quantity of antennas, and wherein the first quantity of one or more antennas and the second quantity of one or more antennas each include a same quantity of antennas that collectively include the at least four antennas.

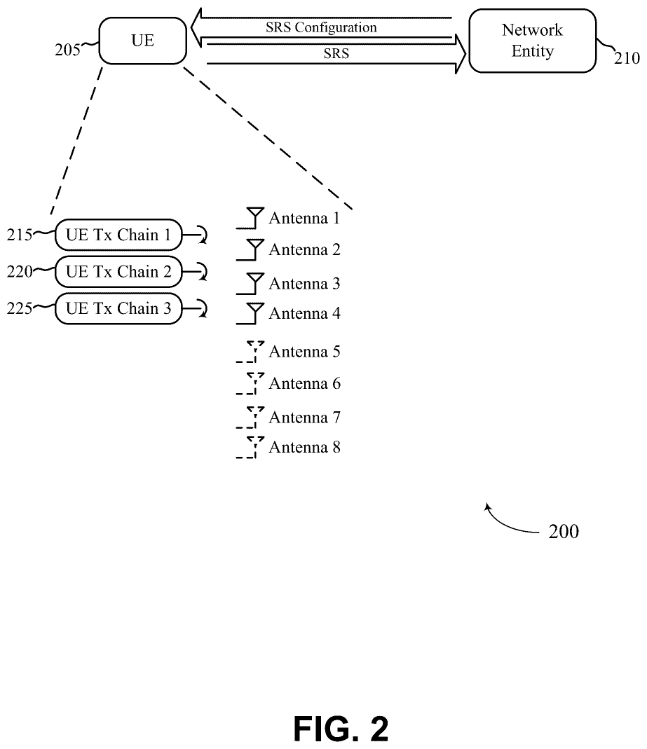

FIG. 2 shows an example of a wireless communications system 200 that supports SRS antenna switch with three transmit chains in accordance with one or more aspects of the present disclosure. Wireless communications system 200 may implement aspects of wireless communications 100. Wireless communications system 200 may include a UE 205 and a network entity 210, which may be aspects of the corresponding devices described herein.

Wireless networks may generally use sounding procedures to “sound” the wireless channel between a transmitting device and a receiving device. This may include one device transmitting a signal over the wireless channel at (e.g., (pre) configured) transmission parameters, such as a fixed transmit power level. The other device may receive the wireless signal at its antenna and measure or otherwise determine various channel performance metrics of the signal. For example, the other device may determine a receive power level, an interference level, a throughput level, or any other metric indicative of the performance of the wireless channel for ongoing wireless communications.

Both devices may use the channel performance metrics for scheduling or other allocation decisions for the ongoing wireless communications. For example, either device may select a different channel (e.g., when the metrics indicate the channel is not suitable for ongoing communications) or adjust various transmission parameters for the ongoing communications based on the measurement results. The adjusted transmission parameters may be selected such that degradation of wireless signals propagated across the channel are mitigated or otherwise accounted for in a manner that improves the success of the ongoing communications. The sounding procedures may include downlink sounding from the network entity 210 to the UE using various reference signals or uplink sounding from the UE 205 to the network entity 210 using SRS transmissions.

For uplink sounding, the UE may be equipped with multiple antennas and each antennas is to be sounded during the sounding procedure. That is, the sounding procedure may include the UE performing SRS transmissions from each antenna in order to identify or otherwise determine the channel performance metrics of each antenna. This may enable the UE and the network to identify or otherwise determine which antenna(s) are better able to support ongoing communications. For example, some antenna(s) of the UE may be blocked by the user or be experiencing other obstructions that interfere with transmissions from that (those) antenna(s). Generally, the UE may have one antenna per receive chain of the UE, such as to support the UE simultaneously monitoring or receiving signals on multiple frequencies. However, the UE may have fewer transmit chains than receive chains. This may lead to antenna switching during SRS sounding transmissions where the UE switches one transmit chain between multiple antennas in order to sound each antenna. SRS antenna switching may enable the UE to sound SRS on uplink channels to help the network measure the uplink channel conditions, and thereby infer the downlink channel conditions (e.g., based on channel reciprocity).

SRS antenna switching may be the UE being configured with x transmit chains (xT) and y receive chains (yR). As each receive chain has a dedicated antenna, y may also be indicative of the number of antennas of the UE. Accordingly, an xTyR SRS sounding mode may assume that the UE has x transmit chains and y receive chains (hence y antennas as one receive chain uses one antenna). Generally, x is less than y and the UE may use the x transmit chain(s) to sound y antennas, which may result in the UE performing antenna switching to sound all y antennas. As one non-limiting example, a 1T4R UE (e.g., a UE with one transmit chain and four receive chains/antennas) may use the single transmit chain to sound all four antennas. The UE may switch or rotate among the four antennas by connecting the transmit chain to each of the antennas one by one and sounding during four different SRS occasions (e.g., sounding occasion).

Wireless networks generally support for SRS antenna switching modes (e.g., SRS configurations) for 1T1R, 1T2R, 1T4R, 1T8R, 2T2R, 2T4R, 2T6R, 2T8R, 4T4R, 4T8R, and 8T8R equipped UE. In each of these modes, y is divisible by x. That is, the UE can conduct the xTyR antenna switching using y/x SRS occasions where x antennas are sounded in each sounding occasion. However, such networks may not support SRS antenna switching modes for a UE equipped with three transmit chains, such as the UE 205. That is, the UE 205 may be equipped with a first transmit chain 215, a second transmit chain 220, and a third transmit chain 225 for a total of three transmit chains. Existing wireless networks support SRS sounding configurations for one, two, four, six, or eight antennas. Such networks may not provide a mechanism for a three port SRS configuration (e.g., having SRS resources for the UE 205 to sound three antennas with three transmit chains during one sounding occasion). Accordingly, such networks may not support 3T4R, 3T6R, or 3T8R SRS configurations for the UE 205.

Accordingly, aspects of the described techniques may support SRS configuration for the UE 205 equipped with three transmit chains. For example, the network entity 210 may transmit or otherwise output (and the UE 205 may receive or otherwise obtain) an indication of a set of sounding occasions. The set of sounding occasions may include or otherwise be based on an SRS configuration that identifies resources for SRS transmissions during the sounding occasions. That is, the set of sounding occasions may include or otherwise identify resources for sounding a total quantity of antennas using the three transmit chains of the UE 205. In some aspects, the total quantity of antennas of the UE 205 may be four antennas. In some aspects, the total quantity of antennas of the UE 205 may be six antennas. In some aspects, the total quantity of antennas of the UE 205 may be eight antennas. In some aspects, the resources may be a four-port SRS configuration. In other aspects, the resources may be a three-port SRS configuration.

The UE 205 may transmit or otherwise output (and the network entity 210 may receive or otherwise obtain) SRS(s) over a first quantity of antenna(s) of the total quantity of antennas via a first group of the three transmit chains during a first sounding occasion in the set of sounding occasions. The first quantity of antenna(s) may be less than the total quantity of antennas. The first group may be any quantity of the three transmit chains. The UE 205 may transmit or otherwise output (and the network entity 210 may receive or otherwise obtain) SRS(s) over a second quantity of antenna(s) of the total quantity of antennas via a second group of the three transmit chains during a second sounding occasion in the set of sounding occasions. The second quantity of antenna(s) may be less than the total quantity of antennas and the second group may be any quantity of the three transmit chains.

In some aspects, the first quantity of antenna(s) and the second quantity of antenna(s) may be different quantities. Collectively, the first quantity of antenna(s) sounded during the first sounding occasion and the second quantity of antenna(s) sounded during the second sounding occasion may total or otherwise include at least four antennas. In some aspects, the antennas included in one quantity of antenna(s) sounded during one sounding occasion may be excluded from the quantity (ies) of antenna(s) sounded during other sounding occasions. That is, the UE 205 may sound each antenna once during the sounding procedure during at least one sounding occasions according to the resources identified in the SRS configuration. The quantities of antenna(s) sounded during each sounding occasion may be based on the number of antennas of the UE 205.

In some aspects where the UE 205 has four antennas, the first quantity of antenna(s) may include three antennas and the first group may include all three of the transmit chains while the second quantity of antenna(s) may include one antenna and the second group may include one of the three transmit chains. Thus, the UE 205 may sound three antennas using all three transmit chains during the first sounding occasion and then sound the one remaining antenna using one of the three transmit chains during the second sounding occasion.

In some aspects where the UE 205 has four antennas, the first quantity of antenna(s) may include one antenna and the first group may include one of the three transmit chains while the second quantity of antenna(s) may include three antennas and the second group may include all three of the three transmit chains. Thus, the UE 205 may sound one antenna using one transmit chain during the first sounding occasion and then sound the remaining three antennas using all of the three transmit chains during the second sounding occasion.

In some aspects where the UE 205 has four antennas, the first quantity of antenna(s) may include two antennas and the first group may include two of the three transmit chains while the second quantity of antennas may include the remaining two antennas and the second group may include two of the three transmit chains. Thus, the UE 205 may sound two antennas using two transmit chains during the first sounding occasion and then sound the remaining two antennas using two of the three transmit chains during the second sounding occasion.

In some aspects where the UE 205 has six antennas, the first quantity of antenna(s) may include three antennas and the first group may include all three of the three transmit chains while the second quantity of antennas may include the remaining three antennas and the second group may again include all three of the three transmit chains. Thus, the UE 205 may sound three antennas using all three of the three transmit chains during the first sounding occasion and then sound the remaining three antennas using all three of the three transmit chains during the second sounding occasion. Accordingly, the resources identified in the SRS configuration may include three or four port SRS configurations being configured for the first and second sounding occasions.

In some aspects where the UE 205 has six antennas and the resources define three sounding occasions, the first quantity of antenna(s) may include three antennas and the first group may include all three of the three transmit chains, the second quantity of antennas may include two of the remaining antennas and the second group may include two of the three transmit chains, and a third quantity of antenna(s) sounded during the third sounding occasion may include one antenna and the third group may include one of the three transmit chains. Thus, the UE 205 may sound three antennas using three transmit chains during the first sounding occasion, sound two of the remaining antennas using two of the three transmit chains during the second sounding occasion, and sound the remaining one antenna using one transmit chain during the third sounding occasions. Accordingly, the resources identified in the SRS configuration may include a three or four port SRS configurations being configured for the first sounding occasion and two port SRS configurations being configured for the second and third sounding occasions.

In some aspects where the UE 205 has six antennas and the resources define three sounding occasions, the first quantity of antenna(s) may include two antennas and the first group may include two of the three transmit chains, the second quantity of antennas may include two of the remaining antennas and the second group may include two of the three transmit chains, and the third quantity of antenna(s) sounded during the third sounding occasion may include the remaining two antennas and the third group may include two of the three transmit chains. Thus, the UE 205 may sound two antennas using two transmit chains during the first sounding occasion, sound two of the remaining antennas using two of the three transmit chains during the second sounding occasion, and sound the remaining two antennas using two transmit chains during the third sounding occasions. Accordingly, the resources identified in the SRS configuration may include a two port SRS configurations being configured for each of the first sounding occasion, the second, and the third sounding occasions.

In some aspects where the UE 205 has eight antennas and the resources define three sounding occasions, the first quantity of antenna(s) may include three antennas and the first group may include all three of the three transmit chains, the second quantity of antenna(s) may include three of the remaining antennas and the second group may include all three of the three transmit chains, and a third quantity of antenna(s) sounded during the third sounding occasion may include two antennas and the third group may include two of the three transmit chains. Thus, the UE 205 may sound three antennas using three transmit chains during the first sounding occasion, sound three of the remaining antennas using all three of the three transmit chains during the second sounding occasion, and sound the remaining two antennas using two transmit chains during the third sounding occasions.

In some aspects where the UE 205 has eight antennas and the resources define three sounding occasions, the first quantity of antenna(s) may include three antennas and the first group may include all three of the three transmit chains, the second quantity of antenna(s) may include two of the remaining antennas and the second group may include two of the three transmit chains, and a third quantity of antenna(s) sounded during the third sounding occasion may include the three antennas and the third group may include all three of the three transmit chains. Thus, the UE 205 may sound three antennas using three transmit chains during the first sounding occasion, sound two of the remaining antennas using two of the three transmit chains during the second sounding occasion, and sound the remaining three antennas using three transmit chains during the third sounding occasions.

In some aspects where the UE 205 has eight antennas and the resources define three sounding occasions, the first quantity of antenna(s) may include two antennas and the first group may include two of the three transmit chains, the second quantity of antenna(s) may include three of the remaining antennas and the second group may include all three of the three transmit chains, and a third quantity of antenna(s) sounded during the third sounding occasion may include the three remaining antennas and the third group may include all three of the three transmit chains. Thus, the UE 205 may sound two antennas using two transmit chains during the first sounding occasion, sound three of the remaining antennas using all three of the three transmit chains during the second sounding occasion, and sound the remaining three antennas using three transmit chains during the third sounding occasions.

As discussed, the resources identified or otherwise indicated in the SRS configuration may, in some aspects, include a four-port SRS configuration to be applied during sounding occasion(s) where the UE 205 sounds three antennas. In this example, at least one of the SRS ports (e.g., the time/frequency resources) is not sounded during the corresponding sounding occasion(s). In other aspects, a three-port SRS configuration may be configured where the resources include three sounding occasions and associated time/frequency resources for the UE 205 to sound three antennas.

In some aspects, different transmit power schemes may be applied during the sounding occasions. The UE 205 may transmit SRS(s) at the same transmit power level during each sounding occasion. In other aspects, the SRS(s) transmitted during different sounding occasions may be transmitted at different transmit power levels.

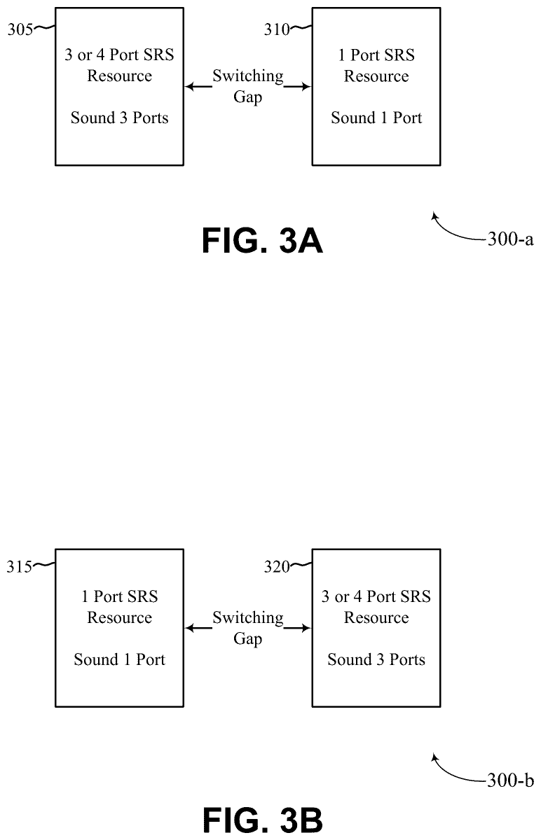

FIGS. 3A-3B show examples of a sounding configuration 300 that supports sounding reference signal antenna switch with three transmit chains in accordance with one or more aspects of the present disclosure. Sounding configuration 300 may implement aspects of wireless communications system 100 or aspects of wireless communications system 200. Aspects of sounding configuration 300 may be implemented at or implemented by a UE or a network entity, which may be examples of the corresponding devices described herein. Sounding configuration 300-a of FIG. 3A illustrates a non-limiting example of a 3T4R UE sounding three antennas using three transmit chains during a first sounding occasion 305 and sounding one antenna using one transmit chain during a second sounding occasion 310. Sounding configuration 300-b of FIG. 3B illustrates a non-limiting example of a 3T4R UE sounding one antenna using one transmit chain during a first sounding occasion 315 and sounding three antennas using three transmit chains during a second sounding occasion 320.

As discussed above, aspects of the described techniques provide various aspects of a 3T UE sounding procedure. For example, the UE may receive or otherwise obtain an indication of a set of sounding occasions. The indication may be provided in an SRS configuration that identifies the sounding occasions and specifies the time, frequency, or spatial resources to be used during each sounding occasion. Broadly, the set of sounding occasions may include or otherwise identify resources for the UE to sound a total quantity of antennas using three transmit chains for the UE. In the non-limiting example illustrated in FIG. 3, the total quantity of antennas of the UE is four antennas.

The UE may transmit SRS(s) over a first quantity of antenna(s) via a first group of the three transmit chains during a first sounding occasion. The first quantity of antenna(s) may be less than the total quantity of antennas and the first group may be any quantity of the three transmit chains. The UE may transmit SRS(s) over a second quantity of antenna(s) via a second group of the three transmit chains during a second sounding occasion. The second quantity of antenna(s) may be less than the total quantity of antennas and the second group may be any quantity of the three transmit chains. In some aspects, the first quantity of antenna(s) and the second quantity of antenna(s) may be different (e.g., unequal port splitting) quantities, but may collectively include the four antennas. The first quantity of antenna(s) may exclude (e.g., not include) the antenna(s) of the second quantity of antenna(s), and vice versa. That is, antenna(s) included in the first quantity of antenna(s) may not be included in the second quantity of antenna(s), or vice versa. Switching gaps may be configured between the first and second sounding occasions to allow the UE to perform antenna switching.

Turning first to sounding configuration 300-a of FIG. 3A, the first quantity of antennas includes three of the four antennas where the first group includes all three of the transmit chains and the second quantity of antennas may include the remaining one antenna of the four antennas where the second group includes one of the three transmit chains. That is, the UE may transmit SRSs using three transmit chains via three antennas during the first sounding occasion 305 and then transmit one SRS using one transmit chain via one antenna during the second sounding occasion 310. In this example, the first sounding occasion may be before the second sounding occasion. The SRS configuration may include a three-port SRS configuration for application during transmission of the SRSs via the first group of transmit chains and then a one-port SRS configuration for application during transmission of the SRS via the second group of transmit chains. The SRS configuration may include a four-port SRS configuration for application during transmission of the SRSs via the first group of transmit chains and then a one-port SRS configuration for application during transmission of the SRS via the second group of transmit chains. Accordingly, in this example the first SRS occasion or resource may be used to sound three antenna ports and the second SRS occasion or resource may be used to sound one antenna port.

Turning next to sounding configuration 300-b of FIG. 3B, the first quantity of antennas includes one of the four antennas where the first group includes one of the three transmit chains and the second quantity of antennas may include the remaining three antennas of the four antennas where the second group includes all three of the three transmit chains. That is, the UE may transmit SRSs using one transmit chain via one antenna during the first sounding occasion 315 and then transmit three SRSs using three transmit chain via three antennas during the second sounding occasion 320. The SRS configuration may include a one-port SRS configuration for application during transmission of the SRS via the first group of transmit chains and then a three-port SRS configuration for application during transmission of the SRSs via the second group of transmit chains. The SRS configuration may include a one-port SRS configuration for application during transmission of the SRS via the first group of transmit chains and then a four-port SRS configuration for application during transmission of the SRSs via the second group of transmit chains. Accordingly, in this example the first SRS occasion or resource may be used to sound one antenna ports and the second SRS occasion or resource may be used to sound three antenna ports.

In other aspects, the UE may be configured with two-port SRS configurations for both the first sounding occasion and the second sounding occasion. In this example, the first quantity of antenna(s) may include two of the four antennas where the first group includes two of the three transmit chains and the second quantity of antennas may include the remaining two antennas of the four antennas where the second group includes two of the three transmit chains. That is, the UE may transmit two SRSs using two transmit chains via two antennas during the first sounding occasion and then transmit two SRSs using two transmit chain via two antennas during the second sounding occasion.

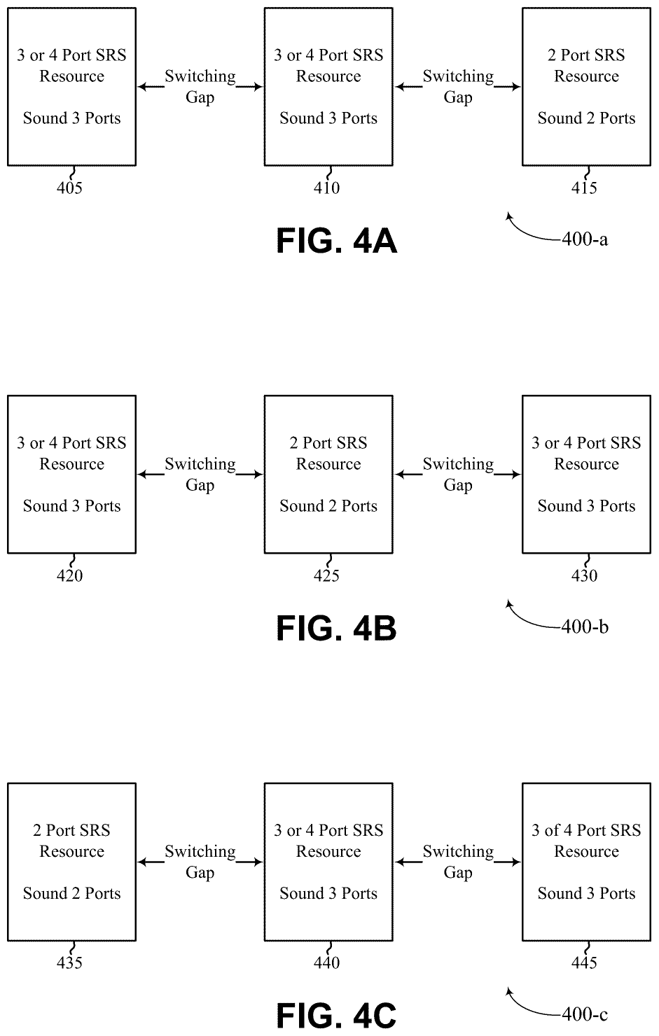

FIGS. 4A-4C show examples of a sounding configuration 400 that supports SRS antenna switch with three transmit chains in accordance with one or more aspects of the present disclosure. Sounding configuration 400 may implement aspects of wireless communications system 100 or aspects of wireless communications system 200. Aspects of sounding configuration 400 may be implemented at or implemented by a UE or a network entity, which may be examples of the corresponding devices described herein. Sounding configuration 400-a of FIG. 4A illustrates a non-limiting example of a 3T8R UE sounding three antennas using three transmit chains during a first sounding occasion 405, sounding three antennas using three transmit chains during a second sounding occasion 410, and sounding two antennas using two transmit chains during a third sounding occasion 415. Sounding configuration 400-b of FIG. 4B illustrates a non-limiting example of a 3T8R UE sounding three antennas using three transmit chains during a first sounding occasion 420, sounding two antennas using two transmit chains during a second sounding occasion 425, and sounding three antennas using three transmit chains during a third sounding occasion 430. Sounding configuration 400-c of FIG. 4C illustrates a non-limiting example of a 3T8R UE sounding two antennas using two transmit chains during a first sounding occasion 435, sounding three antennas using three transmit chains during a second sounding occasion 440, and sounding three antennas using three transmit chains during a third sounding occasion 445.

As discussed above, aspects of the described techniques provide various aspects of a 3T UE sounding procedure. For example, the UE may receive or otherwise obtain an indication of a set of sounding occasions. The indication may be provided in an SRS configuration that identifies the sounding occasions and specifies the time, frequency, or spatial resources to be used during each sounding occasion. Broadly, the set of sounding occasions may include or otherwise identify resources for the UE to sound a total quantity of antennas using three transmit chains for the UE. In the non-limiting example illustrated in FIG. 4, the total quantity of antennas of the UE is eight antennas.

The UE may transmit SRS(s) over a first quantity of antenna(s) via a first group of the three transmit chains during a first sounding occasion. The first quantity of antenna(s) may be less than the total quantity of antennas and the first group may be any quantity of the three transmit chains. The UE may transmit SRS(s) over a second quantity of antenna(s) via a second group of the three transmit chains during a second sounding occasion. The second quantity of antenna(s) may be less than the total quantity of antennas and the second group may be any quantity of the three transmit chains. The UE may transmit SRS(s) over a third quantity of antenna(s) via a third group of the three transmit chains during a third sounding occasion. The third quantity of antenna(s) may be less than the total quantity of antennas and the third group may be any quantity of the three transmit chains.

In some aspects, the first quantity of antenna(s), the second quantity of antenna(s), and the third quantity of antenna(s) may be different (e.g., unequal port splitting) quantities, but may collectively include the eight antennas. The first quantity of antenna(s), the second quantity of antenna(s), and the third quantity of antenna(s) may exclude (e.g., not include) the antenna(s) of the other quantity of antenna(s). That is, antenna(s) included in the first quantity of antenna(s) may not be included in the second quantity of antenna(s) or the third quantity of antenna(s). Antenna(s) included in the second quantity of antenna(s) may not be included in the first quantity of antenna(s) or the third quantity of antenna(s). Antenna(s) in the third quantity of antenna(s) may not be included in the first quantity of antenna(s) or the second quantity of antenna(s). Switching gaps may be configured between the first, second, and third sounding occasions to allow the UE to perform antenna switching.

Turning first to sounding configuration 400-a of FIG. 4A, the first quantity of antennas includes three of the eight antennas where the first group includes all three of the transmit chains, the second quantity of antennas may include another three of the eight antennas where the second group includes all three of the transmit chains, and the third quantity antennas includes the remaining two of the eight antennas where the third group includes two of the three transmit chains. That is, the UE may transmit SRSs using three transmit chains via three antennas during the first sounding occasion 405, transmit three SRSs using three transmit chains via three antennas during the second sounding occasion 410, and transmit two SRSs using two transmit chains via two antennas during the third sounding occasion 415.

The SRS configuration may include a three-port SRS configurations for application during transmission of the SRSs via the first group of transmit chains in the first sounding occasion 405 and via the second group of transmit chains in the second sounding occasion 410 and then a two-port SRS configuration for application during transmission of the SRS via the third group of transmit chains in the third sounding occasion 415. The SRS configuration may include a four-port SRS configurations for application during transmission of the SRSs via the first group of transmit chains in the first sounding occasion 405 and via the second group of transmit chains in the second sounding occasion 410 and then a two-port SRS configuration for application during transmission of the SRS via the third group of transmit chains in the third sounding occasion 415. Accordingly, in this example the first SRS occasion or resource may be used to sound three antenna ports, the second SRS occasion or resource may be used to sound three antenna ports, and the third SRS occasion or resource may be used to sound two antenna ports.

Turning next to sounding configuration 400-b of FIG. 4B, the first quantity of antennas includes three of the eight antennas where the first group includes all three of the transmit chains, the second quantity of antennas may include two of the eight antennas where the second group includes two of the three transmit chains, and the third quantity of antennas includes the remaining three of the eight antennas where the third group includes all of the three transmit chains. That is, the UE may transmit SRSs using three transmit chains via three antennas during the first sounding occasion 420, transmit two SRSs using two transmit chains via two antennas during the second sounding occasion 425, and transmit three SRSs using three transmit chains via three antennas during the third sounding occasion 430.

The SRS configuration may include a three-port SRS configurations for application during transmission of the SRSs via the first group of transmit chains in the first sounding occasion 420 and via the third group of transmit chains in the third sounding occasion 430 and then a two-port SRS configuration for application during transmission of the SRS via the second group of transmit chains in the second sounding occasion 425. The SRS configuration may include a four-port SRS configurations for application during transmission of the SRSs via the first group of transmit chains in the first sounding occasion 420 and via the third group of transmit chains in the third sounding occasion 430 and then a two-port SRS configuration for application during transmission of the SRS via the second group of transmit chains in the second sounding occasion 425. Accordingly, in this example the first SRS occasion or resource may be used to sound three antenna ports, the second SRS occasion or resource may be used to sound two antenna ports, and the third SRS occasion or resource may be used to sound three antenna ports.

Turning last to sounding configuration 400-c of FIG. 4C, the first quantity of antennas includes two of the eight antennas where the first group includes two of the three transmit chains, the second quantity of antennas may include three of the eight antennas where the second group includes all three of the transmit chains, and the third quantity of antennas includes the remaining three of the eight antennas where the third group includes all three of the transmit chains. That is, the UE may transmit SRSs using two transmit chains via two antennas during the first sounding occasion 435, transmit three SRSs using three transmit chains via three antennas during the second sounding occasion 440, and transmit three SRSs using three transmit chains via three antennas during the third sounding occasion 445.

The SRS configuration may include a two-port SRS configurations for application during transmission of the SRSs via the first group of transmit chains in the first sounding occasion 435 and then a three-port SRS configuration for application during transmission of the SRS via the second group of transmit chains in the second sounding occasion 440 and via the third group of transmit chains in the third sounding occasion 445. The SRS configuration may include a two-port SRS configurations for application during transmission of the SRSs via the first group of transmit chains in the first sounding occasion 435 and then a four-port SRS configuration for application during transmission of the SRS via the second group of transmit chains in the second sounding occasion 440 and via the third group of transmit chains in the third sounding occasion 445. Accordingly, in this example the first SRS occasion or resource may be used to sound two antenna ports, the second SRS occasion or resource may be used to sound three antenna ports, and the third SRS occasion or resource may be used to sound three antenna ports.

In other aspects, the set of sounding occasions may include four sounding occasions. In this example, the UE may be configured with a two-port SRS configuration for each sounding occasion. In this example, the first quantity of antennas includes two of the eight antennas where the first group includes two of the three transmit chains, the second quantity of antennas may include two of the eight antennas where the second group includes two of the three transmit chains, the third quantity of antennas includes the two of the eight antennas where the third group includes two of the three transmit chains, and a fourth quantity of antennas sounded during the fourth sounding occasion may include two of the eight antennas where the fourth group includes two of the three transmit chains. That is, the UE may transmit SRSs using two transmit chains via two antennas during the first sounding occasion, transmit SRSs using two transmit chains via two antennas during the second sounding occasion, transmit SRSs using two transmit chains via two antennas during the third sounding occasion, and transmit two SRSs using two transmit chains via two antennas during the fourth sounding occasion.

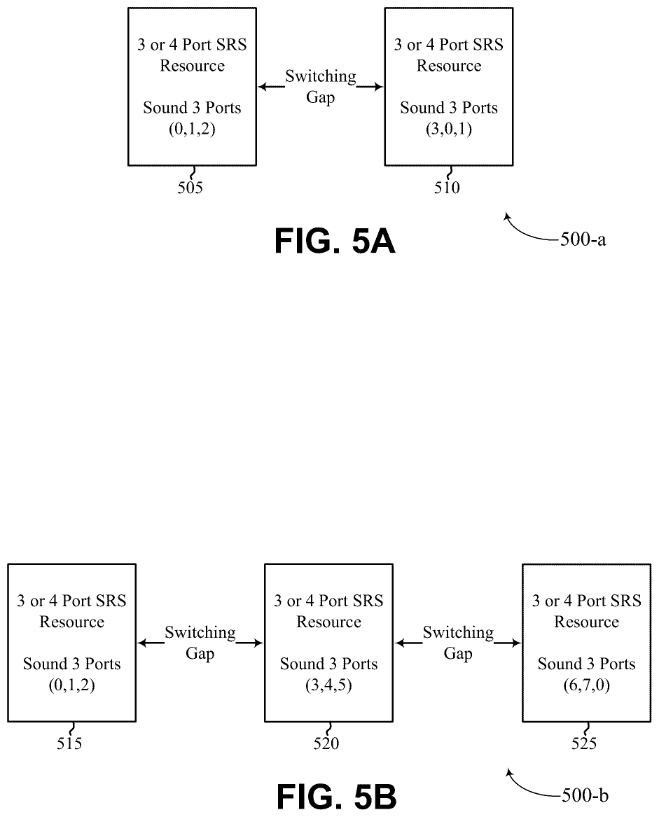

FIGS. 5A-5B show examples of a sounding configuration 500 that supports sounding reference signal antenna switch with three transmit chains in accordance with one or more aspects of the present disclosure. Sounding configuration 500 may implement aspects of wireless communications system 100 or aspects of wireless communications system 200. Aspects of sounding configuration 500 may be implemented at or implemented by a UE or a network entity, which may be examples of the corresponding devices described herein. Sounding configuration 500-a of FIG. 5A illustrates a non-limiting example of a 3T4R UE sounding three antennas using three transmit chains during a first sounding occasion 505 and sounding three antennas using three transmit chains during a second sounding occasion 510. Sounding configuration 500-b of FIG. 5B illustrates a non-limiting example of a 3T8R UE sounding three antennas using three transmit chains during a first sounding occasion 515, sounding three antennas using three transmit chains during a second sounding occasion 520, and sounding three antennas using three transmit chains during a third sounding occasion 525.

As discussed above, aspects of the described techniques provide various aspects of a 3T UE sounding procedure. For example, the UE may receive or otherwise obtain an indication of a set of sounding occasions. The indication may be provided in an SRS configuration that identifies the sounding occasions and specifies the time, frequency, or spatial resources to be used during each sounding occasion. Broadly, the set of sounding occasions may include or otherwise identify resources for the UE to sound a total quantity of antennas using three transmit chains for the UE. In the non-limiting example illustrated in FIG. 5A, the total quantity of antennas of the UE is four antennas. In the non-limiting example illustrated in FIG. 5B, the total quantity of antennas of the UE is eight antennas.

The UE may transmit SRS(s) over a first quantity of antenna(s) via a first group of the three transmit chains during a first sounding occasion. The first quantity of antenna(s) may be less than the total quantity of antennas and the first group may be any quantity of the three transmit chains. The UE may transmit SRS(s) over a second quantity of antenna(s) via a second group of the three transmit chains during a second sounding occasion. The second quantity of antenna(s) may be less than the total quantity of antennas and the second group may be any quantity of the three transmit chains. For a 3T8R UE, the UE may transmit SRS(s) over a third quantity of antenna(s) via a third group of the three transmit chains during a third sounding occasion. The third quantity of antenna(s) may be less than the total quantity of antennas and the third group may be any quantity of the three transmit chains.

In some aspects, the first quantity of antenna(s) and the second quantity of antenna(s) may be the same (e.g., overlapping using equal port splitting) quantities, and may collectively include the four antennas (e.g., for a 3T4R UE). The first quantity of antenna(s) may include the antenna(s) of the second quantity of antenna(s), and vice versa. That is, antenna(s) included in the first quantity of antenna(s) may be included in the second quantity of antenna(s), or vice versa.

In some aspects, the first quantity of antenna(s), the second quantity of antenna(s), and the third quantity of antenna(s) may be the same (e.g., overlapping using equal port splitting) quantities, and may collectively include the eight antennas (e.g., for a 3T8R UE). The first quantity of antenna(s) may include the antenna(s) of the second quantity of antenna(s) or the third quantity of antennas(s). The second quantity of antennas may include antenna(s) of the first quantity of antenna(s) or of the third quantity of antenna(s). The third quantity of antennas may include antenna(s) of the first quantity of antenna(s) or of the second quantity of antenna(s). That is, antenna(s) included in the one quantity of antenna(s) may be included in the other quantity of antenna(s). Switching gaps may be configured between the first and second sounding occasions to allow the UE to perform antenna switching.

Turning first to sounding configuration 500-a of FIG. 5A for a 3T4R UE, the first quantity of antennas includes three of the four antennas where the first group includes all three of the transmit chains and the second quantity of antennas may include the three antennas of the four antennas where the second group includes all three of the transmit chains. That is, in this example where the UE includes four antennas, one or more antennas from the first quantity of antennas are included in the second quantity of antennas. In the non-limiting example shown in FIG. 5A, the first quantity of antennas may include a first antenna (antenna_0), a second antenna (antenna_1), and a third antenna (antenna_2) and the second quantity of antennas may include a fourth antenna (antenna_3), the first antenna (antenna_0), and the second antenna (antenna_1).

Accordingly, the UE may transmit SRSs using three transmit chains via three antennas (e.g., antennas 0-2) during the first sounding occasion 505 and then transmit three SRSs using the three transmit chains via three antennas (e.g., antennas 3 and 0-1) during the second sounding occasion 510. The SRS configuration may include a three-port SRS configuration for application during transmission of the SRSs via the first group of transmit chains and for application during transmission of the SRS via the second group of transmit chains. The SRS configuration may include a four-port SRS configuration for application during transmission of the SRSs via the first group of transmit chains and for application during transmission of the SRS via the second group of transmit chains. Accordingly, in this example with a 3T4R UE, two sounding occasions or resources may be used where the UE sounds three antenna ports during each sounding occasion. The first sounding occasion or resource may be used to sound antenna ports (0,1,2) and the second sounding occasion or resource may be used to sound antenna ports (3,0,1). This may result in antenna ports (0,1) being sounded twice while antenna ports (2,3) being sounded once. In some aspects, which antenna port to be sounded twice (e.g., the overlap in antenna quantities) may be (pre) defined or the network may transmit a signal to the UE indicating which antenna ports are to be sounded multiple times.

Turning next to sounding configuration 500-b of FIG. 5B for a 3T8R UE, the first quantity of antennas includes three of the eight antennas where the first group includes all three of the transmit chains, the second quantity of antennas includes three antennas of the eight antennas where the second group includes all three of the transmit chains, and the third quantity of antennas includes three of the eight antennas where there the third group includes all three of the transmit chains. That is, in this example where the UE includes eight antennas, one or more antennas from the first quantity of antennas are included in the second quantity of antennas or in the third quantity of antennas. In the non-limiting example shown in FIG. 5B, the first quantity of antennas may include a first antenna (antenna_0), a second antenna (antenna_1), and a third antenna (antenna_2), the second quantity of antennas may include a fourth antenna (antenna_3), a fifth antenna (antenna_4), and a sixth antenna (antenna_5), and the third quantity of antennas may include a seventh antenna (antenna_6), an eighth antenna (antenna_7), and the first antenna (antenna_0).

Accordingly, the UE may transmit SRSs using three transmit chains via three antennas (e.g., antennas 0-2) during the first sounding occasion 515, transmit three SRSs using the three transmit chains via three antennas (e.g., antennas 3-5) during the second sounding occasion 520, and transmit three SRSs using the three transmit chains via three antennas (antennas 6, 7, and 0). The SRS configuration may include a three-port SRS configuration for application during transmission of the SRSs via the first group of transmit chains, for application during transmission of the SRS via the second group of transmit chains, and for application during transmission of the SRS via the third group of transmit chains. The SRS configuration may include a four-port SRS configuration for application during transmission of the SRSs via the first group of transmit chains, for application during transmission of the SRS via the second group of transmit chains, and for application during transmission of the SRS via the third group of transmit chains. Accordingly, in this example with a 3T8R UE, three sounding occasions or resources may be used where the UE sounds three antenna ports during each sounding occasion. The first sounding occasion or resource may be used to sound antenna ports (0,1,2), the second sounding occasion or resource may be used to sound antenna ports (3,4,5), and the third sounding occasion or resource may be used to sound antenna ports (6,7,0). This may result in antenna port (0) being sounded twice while antenna ports (1-7) being sounded once. In some aspects, which antenna port to be sounded twice (e.g., the overlap in antenna quantities) may be (pre) defined or the network may transmit a signal to the UE indicating which antenna ports are to be sounded multiple times.

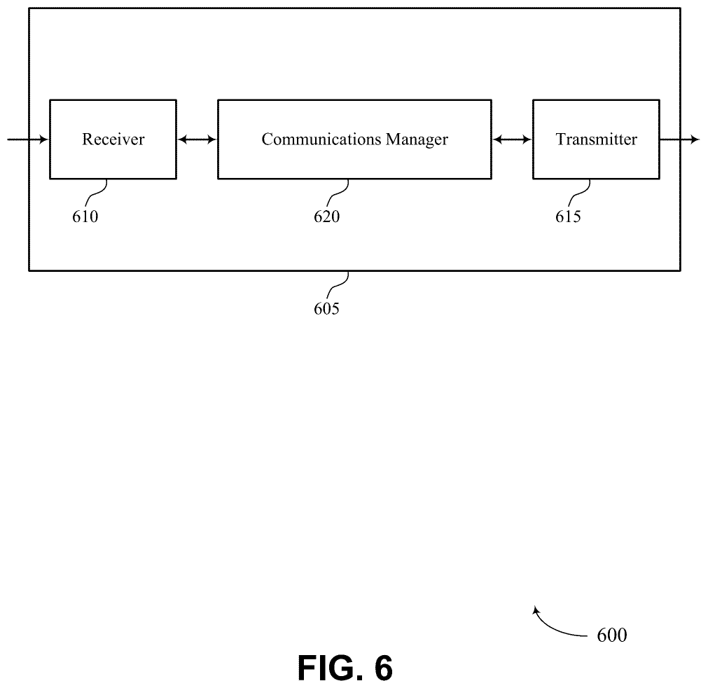

FIG. 6 shows a block diagram 600 of a device 605 that supports sounding reference signal antenna switch with three transmit chains in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to sounding reference signal antenna switch with three transmit chains). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to sounding reference signal antenna switch with three transmit chains). In some aspects, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of sounding reference signal antenna switch with three transmit chains as described herein. For example, the communications manager 620, the receiver 610, the transmitter 615, or various combinations or components thereof may be capable of performing one or more of the functions described herein.

In some aspects, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with aspects as disclosed herein. For example, the communications manager 620 is capable of, configured to, or operable to support a means for receiving an indication of a set of sounding occasions, the set of sounding occasions including resources for sounding a total quantity of antennas using a set of transmit chains of the network entity. The communications manager 620 is capable of, configured to, or operable to support a means for transmitting one or more SRSs over a first quantity of one or more antennas of the total quantity of antennas via a first group of the set of transmit chains during a first sounding occasion in the set of sounding occasions, where the first quantity of one or more antennas is less than the total quantity of antennas, and where the first group is any quantity of the set of transmit chains. The communications manager 620 is capable of, configured to, or operable to support a means for transmitting one or more SRSs over a second quantity of one or more antennas of the total quantity of antennas via a second group of the set of transmit chains during a second sounding occasion in the set of sounding occasions, where the second quantity of one or more antennas is less than the total quantity of antennas, and where the second group is any quantity of the set of transmit chains, and where the first quantity of one or more antennas and the second quantity of one or more antennas are different quantities that collectively include the total quantity of antennas.

Additionally, or alternatively, the communications manager 620 may support wireless communication in accordance with aspects as disclosed herein. For example, the communications manager 620 is capable of, configured to, or operable to support a means for receiving an indication of a set of sounding occasions, the set of sounding occasions including resources for sounding a total quantity of antennas using three transmit chains of the network entity, where the total quantity of antennas includes at least four antennas. The communications manager 620 is capable of, configured to, or operable to support a means for transmitting one or more SRSs over a first quantity of one or more antennas of the total quantity of antennas via the three transmit chains during a first sounding occasion in the set of sounding occasions, where the first quantity of one or more antennas is less than the total quantity of antennas. The communications manager 620 is capable of, configured to, or operable to support a means for transmitting one or more SRSs over a second quantity of one or more antennas of the total quantity of antennas via the three transmit chains during a second sounding occasion in the set of sounding occasions, where the second quantity of one or more antennas is less than all of the total quantity of antennas, and where the first quantity of one or more antennas and the second quantity of antennas each include a same quantity of antennas that collectively include the at least four antennas.

By including or configuring the communications manager 620 in accordance with aspects as described herein, the device 605 (e.g., at least one processor controlling or otherwise coupled with the receiver 610, the transmitter 615, the communications manager 620, or a combination thereof) may support techniques for SRS sounding for a 3TyR UE using existing four-port SRS configurations or using a three-port SRS configuration.

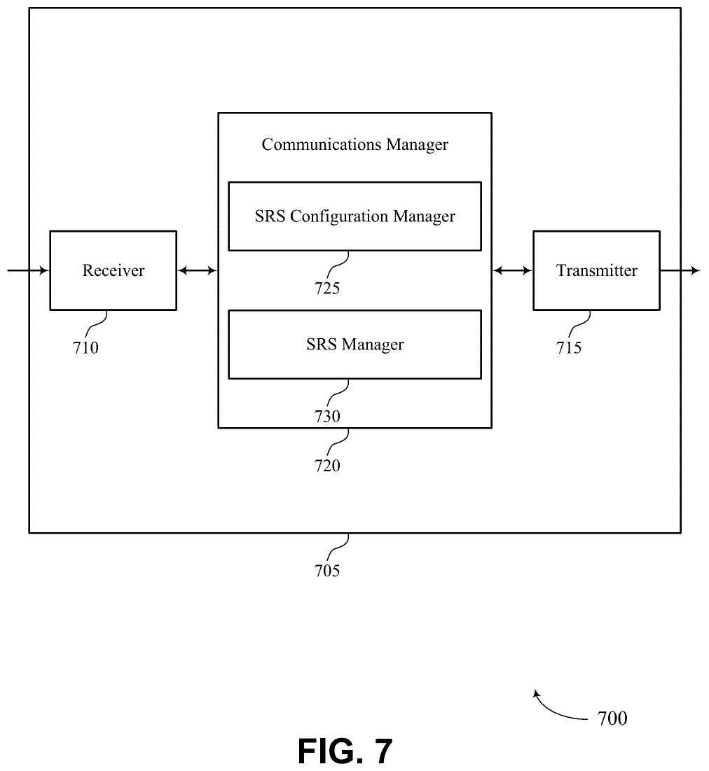

FIG. 7 shows a block diagram 700 of a device 705 that supports sounding reference signal antenna switch with three transmit chains in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to sounding reference signal antenna switch with three transmit chains). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to sounding reference signal antenna switch with three transmit chains). In some aspects, the transmitter 715 may be co-located with a receiver 710 in a transceiver module. The transmitter 715 may utilize a single antenna or a set of multiple antennas.

The device 705, or various components thereof, may be an example of means for performing various aspects of sounding reference signal antenna switch with three transmit chains as described herein. For example, the communications manager 720 may include an SRS configuration manager 725 an SRS manager 730, or any combination thereof. The communications manager 720 may be an example of aspects of a communications manager 620 as described herein. In some aspects, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with aspects as disclosed herein. The SRS configuration manager 725 is capable of, configured to, or operable to support a means for receiving an indication of a set of sounding occasions, the set of sounding occasions including resources for sounding a total quantity of antennas using a set of transmit chains of the network entity. The SRS manager 730 is capable of, configured to, or operable to support a means for transmitting one or more SRSs over a first quantity of one or more antennas of the total quantity of antennas via a first group of the set of transmit chains during a first sounding occasion in the set of sounding occasions, where the first quantity of one or more antennas is less than the total quantity of antennas, and where the first group is any quantity of the set of transmit chains. The SRS manager 730 is capable of, configured to, or operable to support a means for transmitting one or more SRSs over a second quantity of one or more antennas of the total quantity of antennas via a second group of the set of transmit chains during a second sounding occasion in the set of sounding occasions, where the second quantity of one or more antennas is less than the total quantity of antennas, and where the second group is any quantity of the set of transmit chains, and where the first quantity of one or more antennas and the second quantity of one or more antennas are different quantities that collectively include the total quantity of antennas.

Additionally, or alternatively, the communications manager 720 may support wireless communication in accordance with aspects as disclosed herein. The SRS configuration manager 725 is capable of, configured to, or operable to support a means for receiving an indication of a set of sounding occasions, the set of sounding occasions including resources for sounding a total quantity of antennas using three transmit chains of the network entity, where the total quantity of antennas includes at least four antennas. The SRS manager 730 is capable of, configured to, or operable to support a means for transmitting one or more SRSs over a first quantity of one or more antennas of the total quantity of antennas via the three transmit chains during a first sounding occasion in the set of sounding occasions, where the first quantity of one or more antennas is less than the total quantity of antennas. The SRS manager 730 is capable of, configured to, or operable to support a means for transmitting one or more SRSs over a second quantity of one or more antennas of the total quantity of antennas via the three transmit chains during a second sounding occasion in the set of sounding occasions, where the second quantity of one or more antennas is less than all of the total quantity of antennas, and where the first quantity of one or more antennas and the second quantity of antennas each include a same quantity of antennas that collectively include the at least four antennas.

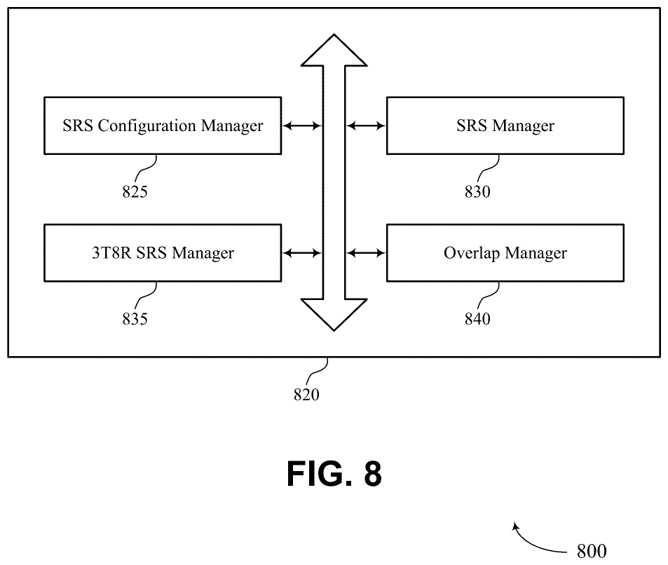

FIG. 8 shows a block diagram 800 of a communications manager 820 that supports sounding reference signal antenna switch with three transmit chains in accordance with one or more aspects of the present disclosure. The communications manager 820 may be an example of aspects of a communications manager 620, a communications manager 720, or both, as described herein. The communications manager 820, or various components thereof, may be an example of means for performing various aspects of sounding reference signal antenna switch with three transmit chains as described herein. For example, the communications manager 820 may include an SRS configuration manager 825, an SRS manager 830, a 3T8R SRS manager 835, an overlap manager 840, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with aspects as disclosed herein. The SRS configuration manager 825 is capable of, configured to, or operable to support a means for receiving an indication of a set of sounding occasions, the set of sounding occasions including resources for sounding a total quantity of antennas using a set of transmit chains of the network entity. The SRS manager 830 is capable of, configured to, or operable to support a means for transmitting one or more SRSs over a first quantity of one or more antennas of the total quantity of antennas via a first group of the set of transmit chains during a first sounding occasion in the set of sounding occasions, where the first quantity of one or more antennas is less than the total quantity of antennas, and where the first group is any quantity of the set of transmit chains. In some aspects, the SRS manager 830 is capable of, configured to, or operable to support a means for transmitting one or more SRSs over a second quantity of one or more antennas of the total quantity of antennas via a second group of the set of transmit chains during a second sounding occasion in the set of sounding occasions, where the second quantity of one or more antennas is less than the total quantity of antennas, and where the second group is any quantity of the set of transmit chains, and where the first quantity of one or more antennas and the second quantity of one or more antennas are different quantities that collectively include the total quantity of antennas.

In some aspects, the set of transmit chains includes three transmit chains, and wherein the total quantity of antennas includes at least four antennas. In some aspects, the first quantity of one or more antennas excludes the one or more antennas of the second quantity of one or more antennas. In some aspects, the second quantity of one or more antennas excludes the one or more antennas of the first quantity of one or more antennas. In some aspects, the total quantity of antennas is four antennas. In some aspects, the first quantity of one or more antennas is three of the four antennas and the first group is all of the three transmit chains. In some aspects, the second quantity of one or more antennas is one of the four antennas and the second group is one of the three transmit chains. In some aspects, the first sounding occasion is before the second sounding occasion. In some aspects, the second sounding occasion is before the first sounding occasion. In some aspects, the resources include a four-port SRS configuration for application during transmission of the one or more SRSs via the first group and a one-port SRS configuration for application during transmission of the one or more SRSs via the second group. In some aspects, the resources include a three-port SRS configuration for application during transmission of the one or more SRSs via the first group and a one-port SRS configuration for application during transmission of the one or more SRSs via the second group.

In some aspects, the 3T8R SRS manager 835 is capable of, configured to, or operable to support a means for transmitting one or more SRSs over a third quantity of one or more antennas of the total quantity of antennas via a third group of the three transmit chains during a third sounding occasion in the set of sounding occasions, where the third quantity of one or more antennas excludes the one or more antennas of the first quantity of one or more antennas and of the second quantity of one or more antennas, and where the third group is any quantity of the three transmit chains.

In some aspects, the total quantity of antennas is eight antennas. In some aspects, the first quantity of one or more antennas is three of the eight antennas and the first group is all of the three transmit chains. In some aspects, the second quantity of one or more antennas is three of the eight antennas and the second group is all of the three transmit chains. In some aspects, the third quantity of one or more antennas is two of the eight antennas and the third group is two of the three transmit chains. In some aspects, the first sounding occasion and the second sounding occasion are before the third sounding occasion. In some aspects, the first sounding occasion is before the third sounding occasion. In some aspects, the third sounding occasion is before the second sounding occasion. In some aspects, the third sounding occasion is before the first sounding occasion and is before the second sounding occasion.

In some aspects, the resources include a four-port SRS configuration for application during transmission of the one or more SRSs via the first group and via the second group and a two-port SRS configuration for application during transmission of the one or more SRSs via the third group. In some aspects, the resources include a three-port SRS configuration for application during transmission of the one or more SRSs via the first group and via the second group and a two-port SRS configuration for application during transmission of the one or more SRSs via the third group. In some aspects, the SRSs transmitted during the first sounding occasion and the second sounding occasion are transmitted at different transmit power levels. In some aspects, the network entity includes a UE. In some aspects, a first number of transmit chains in the set of transmit chains is a smaller number than a second number of antennas in the total quantity of antennas.

Additionally, or alternatively, the communications manager 820 may support wireless communication in accordance with aspects as disclosed herein. In some aspects, the SRS configuration manager 825 is capable of, configured to, or operable to support a means for receiving an indication of a set of sounding occasions, the set of sounding occasions including resources for sounding a total quantity of antennas using three transmit chains of the network entity, where the total quantity of antennas includes at least four antennas. In some aspects, the SRS manager 830 is capable of, configured to, or operable to support a means for transmitting one or more SRSs over a first quantity of one or more antennas of the total quantity of antennas via the three transmit chains during a first sounding occasion in the set of sounding occasions, where the first quantity of one or more antennas is less than the total quantity of antennas. In some aspects, the SRS manager 830 is capable of, configured to, or operable to support a means for transmitting one or more SRSs over a second quantity of one or more antennas of the total quantity of antennas via the three transmit chains during a second sounding occasion in the set of sounding occasions, where the second quantity of one or more antennas is less than all of the total quantity of antennas, and where the first quantity of one or more antennas and the second quantity of antennas each include a same quantity of antennas that collectively include the at least four antennas.

In some aspects, the second quantity of one or more antennas includes at least one antenna from the first quantity of one or more antennas. In some aspects, the total quantity of antennas is four antennas. In some aspects, a quantity of antennas included in each of the first quantity of one or more antennas and the second quantity of one or more antennas is three. In some aspects, the first quantity of one or more antennas includes a first antenna, a second antenna, and a third antenna. In some aspects, the second quantity of one or more antennas includes a fourth antenna, the first antenna, and the second antenna.

In some aspects, the 3T8R SRS manager 835 is capable of, configured to, or operable to support a means for transmitting one or more SRSs over a third quantity of one or more antennas of the total quantity of antennas via a third group of the three transmit chains during a third sounding occasion in the set of sounding occasions. In some aspects, the total quantity of antennas is eight antennas. In some aspects, a quantity of antennas included in each of the first quantity of one or more antennas, the second quantity of one or more antennas, and the third quantity of one or more antennas is three. In some aspects, the first quantity of one or more antennas, the second quantity of one or more antennas, and the third quantity of one or more antennas collectively include all of the eight antennas. In some aspects, the first quantity of one or more antennas includes a first antenna, a second antenna, and a third antennas. In some aspects, the second quantity of one or more antennas includes a fourth antenna, a fifth antenna, and a sixth antenna. In some aspects, the third quantity of one or more antennas includes a seventh antenna, an eighth antenna, and the first antenna. In some aspects, the resources include a four-port SRS configuration for application during transmission of the one or more SRSs via the three transmit chains. In some aspects, the resources include a three-port SRS configuration for application during transmission of the one or more SRSs via the three transmit chains.

In some aspects, the overlap manager 840 is capable of, configured to, or operable to support a means for receiving information identifying an overlap in specific antennas included in each quantity of one or more antennas. In some aspects, the network entity includes a UE.

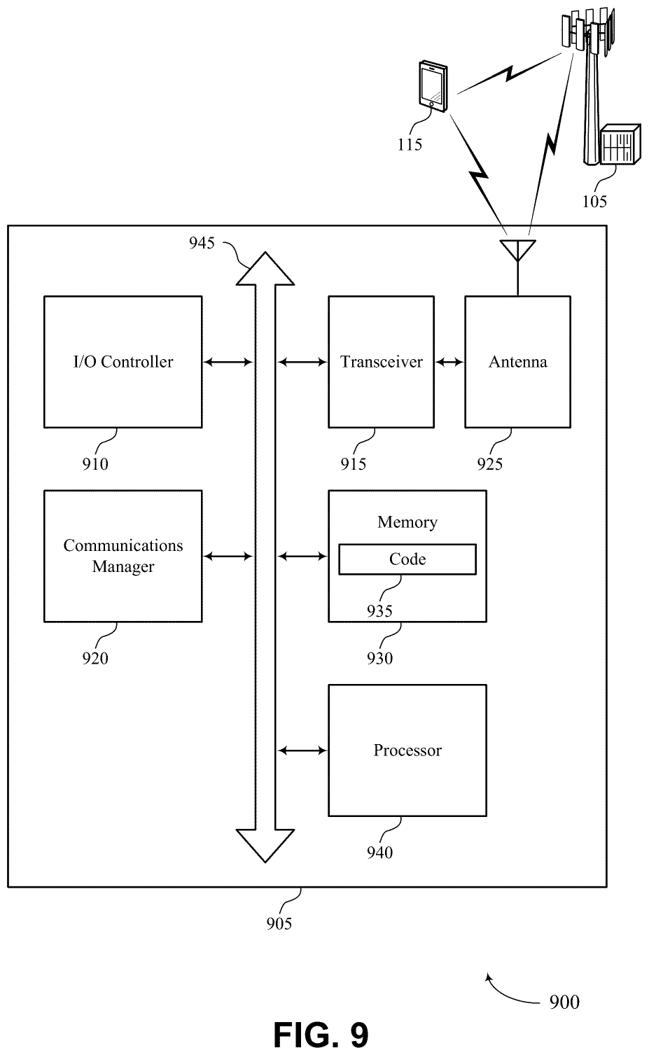

FIG. 9 shows a diagram of a system 900 including a device 905 that supports sounding reference signal antenna switch with three transmit chains in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting sounding reference signal antenna switch with three transmit chains). For example, the device 905 or a component of the device 905 may include at least one processor 940 and at least one memory 930 coupled with or to the at least one processor 940, the at least one processor 940 and the at least one memory 930 configured to perform various functions described herein. In some aspects, the at least one processor 940 may include multiple processors and the at least one memory 930 may include multiple memories. One or more of the multiple processors may be coupled with one or more of the multiple memories, which may, individually or collectively, be configured to perform various functions described herein. In some aspects, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communication in accordance with aspects as disclosed herein. For example, the communications manager 920 is capable of, configured to, or operable to support a means for receiving an indication of a set of sounding occasions, the set of sounding occasions including resources for sounding a total quantity of antennas using a set of transmit chains of the network entity. The communications manager 920 is capable of, configured to, or operable to support a means for transmitting one or more SRSs over a first quantity of one or more antennas of the total quantity of antennas via a first group of the set of transmit chains during a first sounding occasion in the set of sounding occasions, where the first quantity of one or more antennas is less than the total quantity of antennas, and where the first group is any quantity of the set of transmit chains. The communications manager 920 is capable of, configured to, or operable to support a means for transmitting one or more SRSs over a second quantity of one or more antennas of the total quantity of antennas via a second group of the set of transmit chains during a second sounding occasion in the set of sounding occasions, where the second quantity of one or more antennas is less than the total quantity of antennas, and where the second group is any quantity of the set of transmit chains, and where the first quantity of one or more antennas and the second quantity of one or more antennas are different quantities that collectively include the total quantity of antennas.

Additionally, or alternatively, the communications manager 920 may support wireless communication in accordance with aspects as disclosed herein. For example, the communications manager 920 is capable of, configured to, or operable to support a means for receiving an indication of a set of sounding occasions, the set of sounding occasions including resources for sounding a total quantity of antennas using three transmit chains of the network entity, where the total quantity of antennas includes at least four antennas. The communications manager 920 is capable of, configured to, or operable to support a means for transmitting one or more SRSs over a first quantity of one or more antennas of the total quantity of antennas via the three transmit chains during a first sounding occasion in the set of sounding occasions, where the first quantity of one or more antennas is less than the total quantity of antennas. The communications manager 920 is capable of, configured to, or operable to support a means for transmitting one or more SRSs over a second quantity of one or more antennas of the total quantity of antennas via the three transmit chains during a second sounding occasion in the set of sounding occasions, where the second quantity of one or more antennas is less than all of the total quantity of antennas, and where the first quantity of one or more antennas and the second quantity of antennas each include a same quantity of antennas that collectively include the at least four antennas.

By including or configuring the communications manager 920 in accordance with aspects as described herein, the device 905 may support techniques for SRS sounding for a 3TyR UE using existing four-port SRS configurations or using a three-port SRS configuration.

In some aspects, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some aspects, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of sounding reference signal antenna switch with three transmit chains as described herein, or the at least one processor 940 and the at least one memory 930 may be otherwise configured to, individually or collectively, perform or support such operations.

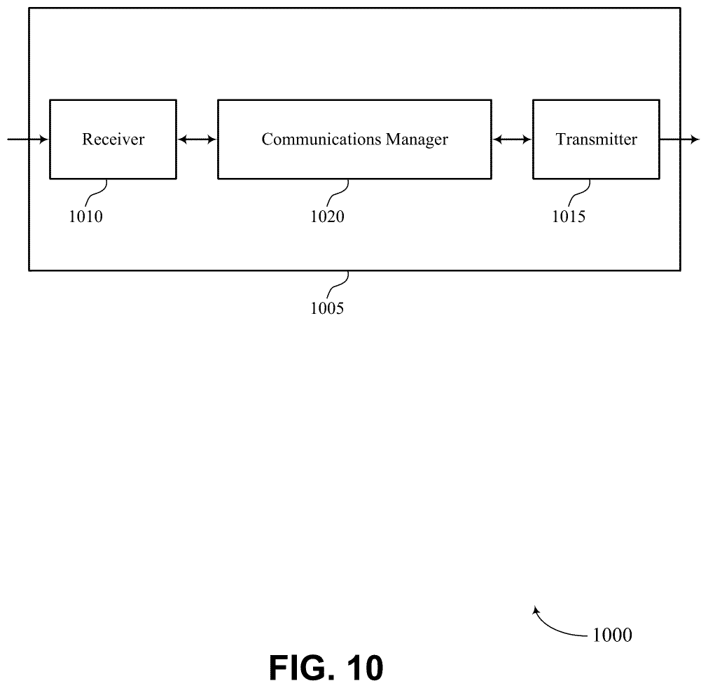

FIG. 10 shows a block diagram 1000 of a device 1005 that supports sounding reference signal antenna switch with three transmit chains in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some aspects, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some aspects, the transmitter 1015 and the receiver 1010 may be co-located in a transceiver, which may include or be coupled with a modem.

The communications manager 1020, the receiver 1010, the transmitter 1015, or various combinations or components thereof may be aspects of means for performing various aspects of sounding reference signal antenna switch with three transmit chains as described herein. For example, the communications manager 1020, the receiver 1010, the transmitter 1015, or various combinations or components thereof may be capable of performing one or more of the functions described herein.

In some aspects, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with aspects as disclosed herein. For example, the communications manager 1020 is capable of, configured to, or operable to support a means for transmitting, to a UE, an indication of a set of sounding occasions, the set of sounding occasions including resources for sounding a total quantity of antennas using a set of transmit chains of the UE. The communications manager 1020 is capable of, configured to, or operable to support a means for receiving, from the UE, one or more SRSs over a first quantity of one or more antennas of the total quantity of antennas via a first group of the set of transmit chains during a first sounding occasion in the set of sounding occasions, where the first quantity of one or more antennas is less than the total quantity of antennas and the first group is any quantity of the set of transmit chains. The communications manager 1020 is capable of, configured to, or operable to support a means for receiving, from the UE, one or more SRSs over a second quantity of one or more antennas of the total quantity of antennas via a second group of the set of transmit chains during a second sounding occasion in the set of sounding occasions, where the second quantity of one or more antennas is less than the total quantity of antennas and the second group is any quantity of the set of transmit chains, and where the first quantity of one or more antennas and the second quantity of one or more antennas are different quantities that collectively include the total quantity of antennas.

Additionally, or alternatively, the communications manager 1020 may support wireless communication in accordance with aspects as disclosed herein. For example, the communications manager 1020 is capable of, configured to, or operable to support a means for transmitting, to a UE, an indication of a set of sounding occasions, the set of sounding occasions including resources for sounding a total quantity of antennas using three transmit chains of the UE, where the total quantity of antennas includes at least four antennas. The communications manager 1020 is capable of, configured to, or operable to support a means for receiving, from the UE, one or more SRSs over a first quantity of one or more antennas of the total quantity of antennas via the three transmit chains during a first sounding occasion in the set of sounding occasions, where the first quantity of one or more antennas is less than the total quantity of antennas. The communications manager 1020 is capable of, configured to, or operable to support a means for receiving, from the UE, one or more SRSs over a second quantity of one or more antennas of the total quantity of antennas via the three transmit chains during a second sounding occasion in the set of sounding occasions, where the second quantity of one or more antennas is less than the total quantity of antennas, and where the first quantity of one or more antennas and the second quantity of one or more antennas each include a same quantity of antennas that collectively include the at least four antennas.

By including or configuring the communications manager 1020 in accordance with aspects as described herein, the device 1005 (e.g., at least one processor controlling or otherwise coupled with the receiver 1010, the transmitter 1015, the communications manager 1020, or a combination thereof) may support techniques for SRS sounding for a 3TyR UE using existing four-port SRS configurations or using a three-port SRS configuration.

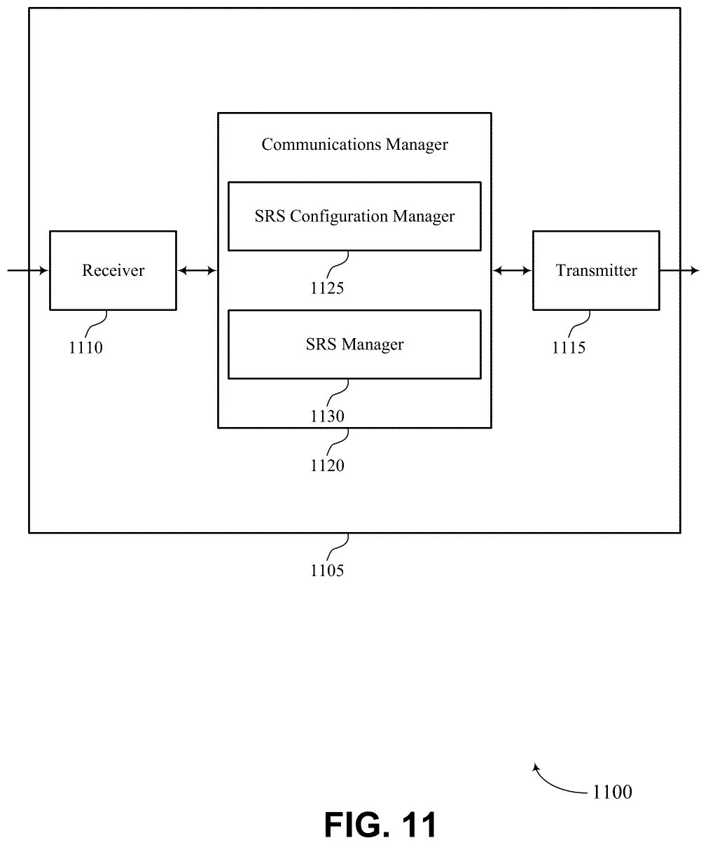

FIG. 11 shows a block diagram 1100 of a device 1105 that supports sounding reference signal antenna switch with three transmit chains in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some aspects, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some aspects, the transmitter 1115 and the receiver 1110 may be co-located in a transceiver, which may include or be coupled with a modem.

The device 1105, or various components thereof, may be an example of means for performing various aspects of sounding reference signal antenna switch with three transmit chains as described herein. For example, the communications manager 1120 may include an SRS configuration manager 1125 an SRS manager 1130, or any combination thereof. The communications manager 1120 may be an example of aspects of a communications manager 1020 as described herein. In some aspects, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with aspects as disclosed herein. The SRS configuration manager 1125 is capable of, configured to, or operable to support a means for transmitting, to a UE, an indication of a set of sounding occasions, the set of sounding occasions including resources for sounding a total quantity of antennas using a set of transmit chains of the UE. The SRS manager 1130 is capable of, configured to, or operable to support a means for receiving, from the UE, one or more SRSs over a first quantity of one or more antennas of the total quantity of antennas via a first group of the set of transmit chains during a first sounding occasion in the set of sounding occasions, where the first quantity of one or more antennas is less than the total quantity of antennas and the first group is any quantity of the set of transmit chains. The SRS manager 1130 is capable of, configured to, or operable to support a means for receiving, from the UE, one or more SRSs over a second quantity of one or more antennas of the total quantity of antennas via a second group of the set of transmit chains during a second sounding occasion in the set of sounding occasions, where the second quantity of one or more antennas is less than the total quantity of antennas and the second group is any quantity of the set of transmit chains, and where the first quantity of one or more antennas and the second quantity of one or more antennas are different quantities that collectively include the total quantity of antennas.

Additionally, or alternatively, the communications manager 1120 may support wireless communication in accordance with aspects as disclosed herein. The SRS configuration manager 1125 is capable of, configured to, or operable to support a means for transmitting, to a UE, an indication of a set of sounding occasions, the set of sounding occasions including resources for sounding a total quantity of antennas using three transmit chains of the UE, where the total quantity of antennas includes at least four antennas. The SRS manager 1130 is capable of, configured to, or operable to support a means for receiving, from the UE, one or more SRSs over a first quantity of one or more antennas of the total quantity of antennas via the three transmit chains during a first sounding occasion in the set of sounding occasions, where the first quantity of one or more antennas is less than the total quantity of antennas. The SRS manager 1130 is capable of, configured to, or operable to support a means for receiving, from the UE, one or more SRSs over a second quantity of one or more antennas of the total quantity of antennas via the three transmit chains during a second sounding occasion in the set of sounding occasions, where the second quantity of one or more antennas is less than the total quantity of antennas, and where the first quantity of one or more antennas and the second quantity of one or more antennas each include a same quantity of antennas that collectively include the at least four antennas.

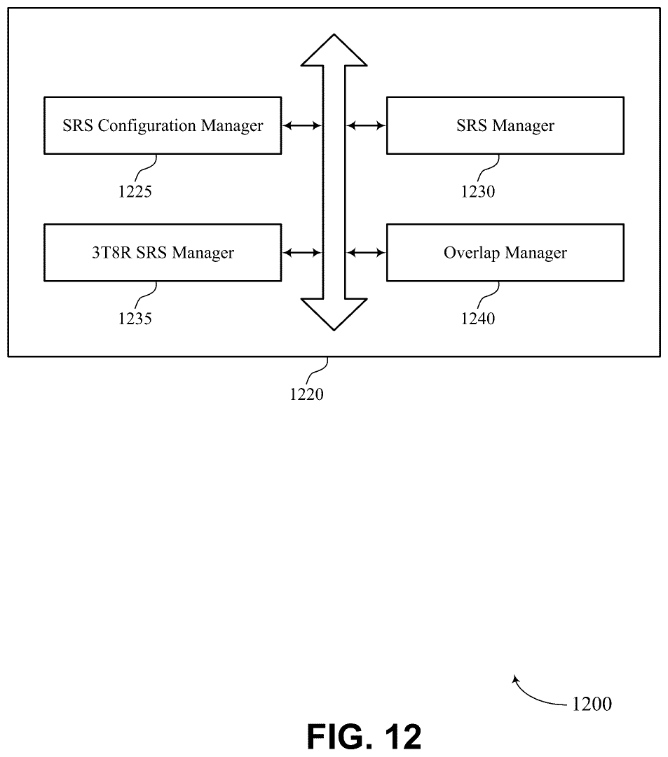

FIG. 12 shows a block diagram 1200 of a communications manager 1220 that supports sounding reference signal antenna switch with three transmit chains in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of sounding reference signal antenna switch with three transmit chains as described herein. For example, the communications manager 1220 may include an SRS configuration manager 1225, an SRS manager 1230, a 3T8R SRS manager 1235, an overlap manager 1240, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication in accordance with aspects as disclosed herein. The SRS configuration manager 1225 is capable of, configured to, or operable to support a means for transmitting, to a UE, an indication of a set of sounding occasions, the set of sounding occasions including resources for sounding a total quantity of antennas using a set of transmit chains of the UE. The SRS manager 1230 is capable of, configured to, or operable to support a means for receiving, from the UE, one or more SRSs over a first quantity of one or more antennas of the total quantity of antennas via a first group of the set of transmit chains during a first sounding occasion in the set of sounding occasions, where the first quantity of one or more antennas is less than the total quantity of antennas and the first group is any quantity of the set of transmit chains. In some aspects, the SRS manager 1230 is capable of, configured to, or operable to support a means for receiving, from the UE, one or more SRSs over a second quantity of one or more antennas of the total quantity of antennas via a second group of the set of transmit chains during a second sounding occasion in the set of sounding occasions, where the second quantity of one or more antennas is less than the total quantity of antennas and the second group is any quantity of the set of transmit chains, and where the first quantity of one or more antennas and the second quantity of one or more antennas are different quantities that collectively include the total quantity of antennas.

In some aspects, the set of transmit chains includes three transmit chains, and wherein the total quantity of antennas includes at least four antennas. In some aspects, the first quantity of one or more antennas excludes the one or more antennas of the second quantity of one or more antennas. In some aspects, the second quantity of one or more antennas excludes the one or more antennas of the first quantity of one or more antennas. In some aspects, the total quantity of antennas is four antennas. In some aspects, the first quantity of one or more antennas is three of the four antennas and the first group is all of the three transmit chains. In some aspects, the second quantity of one or more antennas is one of the four antennas and the second group is one of the three transmit chains. In some aspects, the first sounding occasion is before the second sounding occasion. In some aspects, the second sounding occasion is before the first sounding occasion. In some aspects, the resources include a four-port SRS configuration for application during transmission of the one or more SRSs via the first group and a one-port SRS configuration for application during transmission of the one or more SRSs via the second group. In some aspects, the resources include a three-port SRS configuration for application during transmission of the one or more SRSs via the first group and a one-port SRS configuration for application during transmission of the one or more SRSs via the second group.

In some aspects, the 3T8R SRS manager 1235 is capable of, configured to, or operable to support a means for receiving, from the UE, one or more SRSs over a third quantity of one or more antennas of the total quantity of antennas via a third group of the three transmit chains during a third sounding occasion in the set of sounding occasions, where the third quantity of one or more antennas excludes the one or more antennas of the first quantity of one or more antennas and of the second quantity of one or more antennas, and where the third group is any quantity of the three transmit chains.

In some aspects, the total quantity of antennas is eight antennas. In some aspects, the first quantity of one or more antennas is three of the eight antennas and the first group is all of the three transmit chains. In some aspects, the second quantity of one or more antennas is three of the eight antennas and the second group is all of the three transmit chains. In some aspects, the third quantity of one or more antennas is two of the eight antennas and the third group is two of the three transmit chains. In some aspects, the first sounding occasion and the second sounding occasion are before the third sounding occasion. In some aspects, the first sounding occasion is before the third sounding occasion. In some aspects, the third sounding occasion is before the second sounding occasion.

In some aspects, the third sounding occasion is before the first sounding occasion and is before the second sounding occasion. In some aspects, the resources include a four-port SRS configuration for application during transmission of the one or more SRSs via the first group and via the second group and a two-port SRS configuration for application during transmission of the one or more SRSs via the third group. In some aspects, the resources include a three-port SRS configuration for application during transmission of the one or more SRSs via the first group and via the second group and a two-port SRS configuration for application during transmission of the one or more SRSs via the third group. In some aspects, the SRSs transmitted during the first sounding occasion and the second sounding occasion are transmitted by the UE at different transmit power levels. In some aspects, a first number of transmit chains in the set of transmit chains is a smaller number than a second number of antennas in the total quantity of antennas.

Additionally, or alternatively, the communications manager 1220 may support wireless communication in accordance with aspects as disclosed herein. In some aspects, the SRS configuration manager 1225 is capable of, configured to, or operable to support a means for transmitting, to a UE, an indication of a set of sounding occasions, the set of sounding occasions including resources for sounding a total quantity of antennas using three transmit chains of the UE, where the total quantity of antennas includes at least four antennas. In some aspects, the SRS manager 1230 is capable of, configured to, or operable to support a means for receiving, from the UE, one or more SRSs over a first quantity of one or more antennas of the total quantity of antennas via the three transmit chains during a first sounding occasion in the set of sounding occasions, where the first quantity of one or more antennas is less than the total quantity of antennas. In some aspects, the SRS manager 1230 is capable of, configured to, or operable to support a means for receiving, from the UE, one or more SRSs over a second quantity of one or more antennas of the total quantity of antennas via the three transmit chains during a second sounding occasion in the set of sounding occasions, where the second quantity of one or more antennas is less than the total quantity of antennas, and where the first quantity of one or more antennas and the second quantity of one or more antennas each include a same quantity of antennas that collectively include the at least four antennas.

In some aspects, the second quantity of one or more antennas includes at least one antennas from the first quantity of one or more antennas. In some aspects, the total quantity of antennas includes four antennas. In some aspects, a quantity of antennas included in each of the first quantity of one or more antennas and the second quantity of one or more antennas is three. In some aspects, the first quantity of one or more antennas includes a first antenna, a second antenna, and a third antenna. In some aspects, the second quantity of one or more antennas includes a fourth antenna, the first antenna, and the second antenna.

In some aspects, the 3T8R SRS manager 1235 is capable of, configured to, or operable to support a means for receiving, from the UE, one or more SRSs over a third quantity of one or more antennas of the total quantity of antennas via a third group of the three transmit chains during a third sounding occasion in the set of sounding occasions.

In some aspects, the total quantity of antennas is eight antennas. In some aspects, a quantity of antennas included in each of the first quantity of one or more antennas, the second quantity of one or more antennas, and the third quantity of one or more antennas is three. In some aspects, the first quantity of one or more antennas, the second quantity of one or more antennas, and the third quantity of one or more antennas collectively include all of the eight antennas. In some aspects, the first quantity of one or more antennas includes a first antenna, a second antenna, and a third antennas. In some aspects, the second quantity of one or more antennas includes a fourth antenna, a fifth antenna, and a sixth antenna. In some aspects, the third quantity of one or more antennas includes a seventh antenna, an eighth antenna, and the first antenna. In some aspects, the resources include a four-port SRS configuration for application during transmission of the one or more SRSs via the three transmit chains. In some aspects, the resources include a three-port SRS configuration for application during transmission of the one or more SRSs via the three transmit chains.

In some aspects, the overlap manager 1240 is capable of, configured to, or operable to support a means for transmitting, to the UE, information identifying an overlap in specific antennas included in each quantity of one or more antennas.

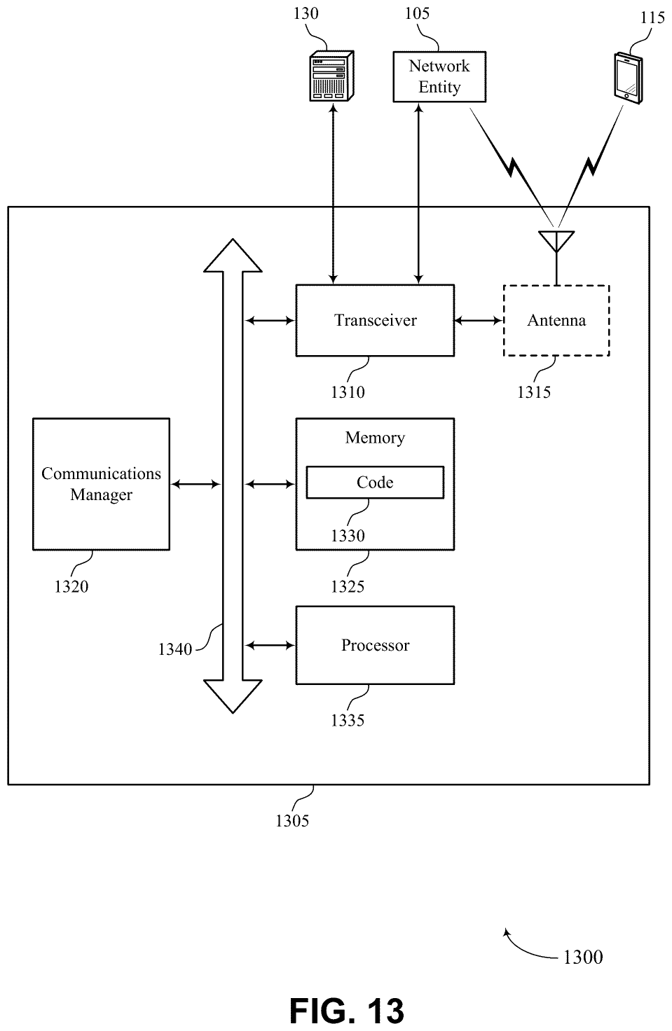

FIG. 13 shows a diagram of a system 1300 including a device 1305 that supports sounding reference signal antenna switch with three transmit chains in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some aspects, the transceiver 1310 may include a wired transceiver and may communicate bi-directionally with another wired transceiver. Additionally, or alternatively, in some aspects, the transceiver 1310 may include a wireless transceiver and may communicate bi-directionally with another wireless transceiver. In some aspects, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some aspects, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some aspects, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting sounding reference signal antenna switch with three transmit chains). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some aspects, the at least one processor 1335 may include multiple processors and the at least one memory 1325 may include multiple memories. One or more of the multiple processors may be coupled with one or more of the multiple memories, which may, individually or collectively, be configured to perform various functions herein. In some aspects, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some aspects, a bus 1340 may support communications of (e.g., within) a protocol layer of a protocol stack. In some aspects, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some aspects, the communications manager 1320 may manage aspects of communications with a core network 130 (e.g., via one or more wired or wireless backhaul links). For example, the communications manager 1320 may manage the transfer of data communications for client devices, such as one or more UEs 115. In some aspects, the communications manager 1320 may manage communications with one or more other network devices 105, and may include a controller or scheduler for controlling communications with UEs 115 (e.g., in cooperation with the one or more other network devices). In some aspects, the communications manager 1320 may support an X2 interface within an LTE/LTE-A wireless communications network technology to provide communication between network entities 105.

The communications manager 1320 may support wireless communication in accordance with aspects as disclosed herein. For example, the communications manager 1320 is capable of, configured to, or operable to support a means for transmitting, to a UE, an indication of a set of sounding occasions, the set of sounding occasions including resources for sounding a total quantity of antennas using a set of transmit chains of the UE. The communications manager 1320 is capable of, configured to, or operable to support a means for receiving, from the UE, one or more SRSs over a first quantity of one or more antennas of the total quantity of antennas via a first group of the set of transmit chains during a first sounding occasion in the set of sounding occasions, where the first quantity of one or more antennas is less than the total quantity of antennas and the first group is any quantity of the set of transmit chains. The communications manager 1320 is capable of, configured to, or operable to support a means for receiving, from the UE, one or more SRSs over a second quantity of one or more antennas of the total quantity of antennas via a second group of the set of transmit chains during a second sounding occasion in the set of sounding occasions, where the second quantity of one or more antennas is less than the total quantity of antennas and the second group is any quantity of the set of transmit chains, and where the first quantity of one or more antennas and the second quantity of one or more antennas are different quantities that collectively include the total quantity of antennas.

Additionally, or alternatively, the communications manager 1320 may support wireless communication in accordance with aspects as disclosed herein. For example, the communications manager 1320 is capable of, configured to, or operable to support a means for transmitting, to a UE, an indication of a set of sounding occasions, the set of sounding occasions including resources for sounding a total quantity of antennas using three transmit chains of the UE, where the total quantity of antennas includes at least four antennas. The communications manager 1320 is capable of, configured to, or operable to support a means for receiving, from the UE, one or more SRSs over a first quantity of one or more antennas of the total quantity of antennas via the three transmit chains during a first sounding occasion in the set of sounding occasions, where the first quantity of one or more antennas is less than the total quantity of antennas. The communications manager 1320 is capable of, configured to, or operable to support a means for receiving, from the UE, one or more SRSs over a second quantity of one or more antennas of the total quantity of antennas via the three transmit chains during a second sounding occasion in the set of sounding occasions, where the second quantity of one or more antennas is less than the total quantity of antennas, and where the first quantity of one or more antennas and the second quantity of one or more antennas each include a same quantity of antennas that collectively include the at least four antennas.

By including or configuring the communications manager 1320 in accordance with aspects as described herein, the device 1305 may support techniques for SRS sounding for a 3TyR UE using existing four-port SRS configurations or using a three-port SRS configuration.

In some aspects, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some aspects, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of sounding reference signal antenna switch with three transmit chains as described herein, or the at least one processor 1335 and the at least one memory 1325 may be otherwise configured to, individually or collectively, perform or support such operations.

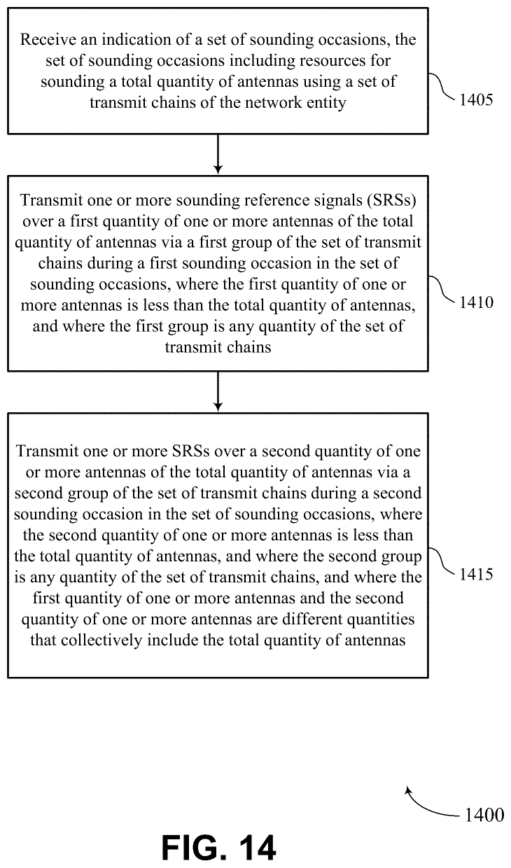

FIG. 14 shows a flowchart illustrating a method 1400 that supports sounding reference signal antenna switch with three transmit chains in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some aspects, a UE may execute a set of instructions to control the functional elements of the UE to perform the described functions. Additionally, or alternatively, the UE may perform aspects of the described functions using special-purpose hardware.

At 1405, the method may include receiving an indication of a set of sounding occasions, the set of sounding occasions including resources for sounding a total quantity of antennas using a set of transmit chains of the network entity. The operations of 1405 may be performed in accordance with aspects as disclosed herein. In some aspects, aspects of the operations of 1405 may be performed by an SRS configuration manager 825 as described with reference to FIG. 8.

At 1410, the method may include transmitting one or more SRSs over a first quantity of one or more antennas of the total quantity of antennas via a first group of the set of transmit chains during a first sounding occasion in the set of sounding occasions, where the first quantity of one or more antennas is less than the total quantity of antennas, and where the first group is any quantity of the set of transmit chains. The operations of 1410 may be performed in accordance with aspects as disclosed herein. In some aspects, aspects of the operations of 1410 may be performed by an SRS manager 830 as described with reference to FIG. 8.

At 1415, the method may include transmitting one or more SRSs over a second quantity of one or more antennas of the total quantity of antennas via a second group of the set of transmit chains during a second sounding occasion in the set of sounding occasions, where the second quantity of one or more antennas is less than the total quantity of antennas, and where the second group is any quantity of the set of transmit chains, and where the first quantity of one or more antennas and the second quantity of one or more antennas are different quantities that collectively include the total quantity of antennas. The operations of 1415 may be performed in accordance with aspects as disclosed herein. In some aspects, aspects of the operations of 1415 may be performed by an SRS manager 830 as described with reference to FIG. 8.

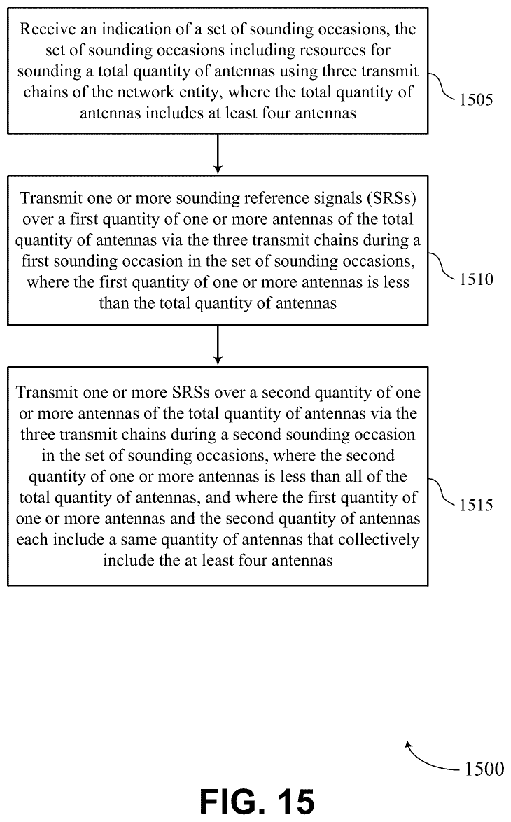

FIG. 15 shows a flowchart illustrating a method 1500 that supports sounding reference signal antenna switch with three transmit chains in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some aspects, a UE may execute a set of instructions to control the functional elements of the UE to perform the described functions. Additionally, or alternatively, the UE may perform aspects of the described functions using special-purpose hardware.

At 1505, the method may include receiving an indication of a set of sounding occasions, the set of sounding occasions including resources for sounding a total quantity of antennas using three transmit chains of the network entity, where the total quantity of antennas includes at least four antennas. The operations of 1505 may be performed in accordance with aspects as disclosed herein. In some aspects, aspects of the operations of 1505 may be performed by an SRS configuration manager 825 as described with reference to FIG. 8.

At 1510, the method may include transmitting one or more SRSs over a first quantity of one or more antennas of the total quantity of antennas via the three transmit chains during a first sounding occasion in the set of sounding occasions, where the first quantity of one or more antennas is less than the total quantity of antennas. The operations of 1510 may be performed in accordance with aspects as disclosed herein. In some aspects, aspects of the operations of 1510 may be performed by an SRS manager 830 as described with reference to FIG. 8.

At 1515, the method may include transmitting one or more SRSs over a second quantity of one or more antennas of the total quantity of antennas via the three transmit chains during a second sounding occasion in the set of sounding occasions, where the second quantity of one or more antennas is less than all of the total quantity of antennas, and where the first quantity of one or more antennas and the second quantity of antennas each include a same quantity of antennas that collectively include the at least four antennas. The operations of 1515 may be performed in accordance with aspects as disclosed herein. In some aspects, aspects of the operations of 1515 may be performed by an SRS manager 830 as described with reference to FIG. 8.

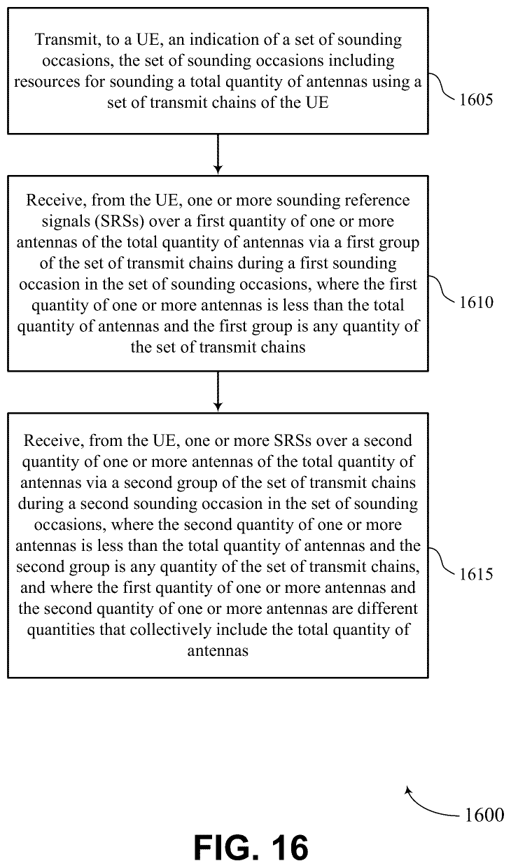

FIG. 16 shows a flowchart illustrating a method 1600 that supports sounding reference signal antenna switch with three transmit chains in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some aspects, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, an indication of a set of sounding occasions, the set of sounding occasions including resources for sounding a total quantity of antennas using a set of transmit chains of the UE. The operations of 1605 may be performed in accordance with aspects as disclosed herein. In some aspects, aspects of the operations of 1605 may be performed by an SRS configuration manager 1225 as described with reference to FIG. 12.

At 1610, the method may include receiving, from the UE, one or more SRSs over a first quantity of one or more antennas of the total quantity of antennas via a first group of the set of transmit chains during a first sounding occasion in the set of sounding occasions, where the first quantity of one or more antennas is less than the total quantity of antennas and the first group is any quantity of the set of transmit chains. The operations of 1610 may be performed in accordance with aspects as disclosed herein. In some aspects, aspects of the operations of 1610 may be performed by an SRS manager 1230 as described with reference to FIG. 12.

At 1615, the method may include receiving, from the UE, one or more SRSs over a second quantity of one or more antennas of the total quantity of antennas via a second group of the set of transmit chains during a second sounding occasion in the set of sounding occasions, where the second quantity of one or more antennas is less than the total quantity of antennas and the second group is any quantity of the set of transmit chains, and where the first quantity of one or more antennas and the second quantity of one or more antennas are different quantities that collectively include the total quantity of antennas. The operations of 1615 may be performed in accordance with aspects as disclosed herein. In some aspects, aspects of the operations of 1615 may be performed by an SRS manager 1230 as described with reference to FIG. 12.

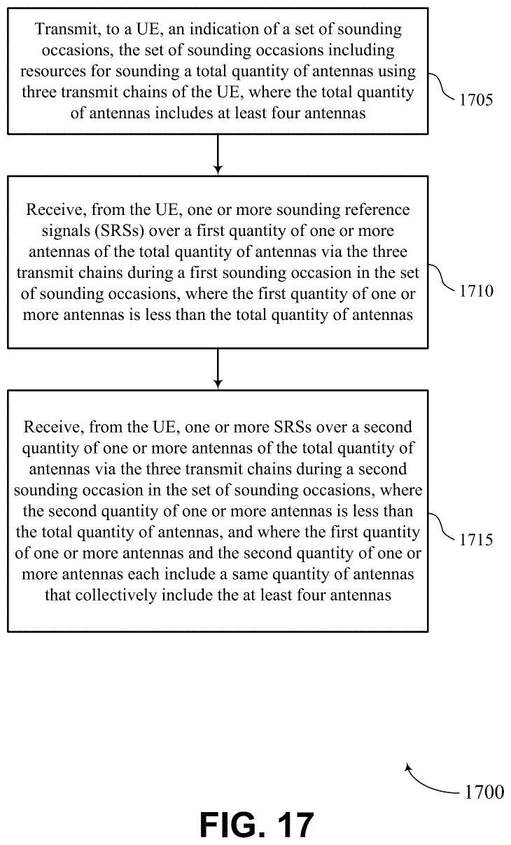

FIG. 17 shows a flowchart illustrating a method 1700 that supports sounding reference signal antenna switch with three transmit chains in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some aspects, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, an indication of a set of sounding occasions, the set of sounding occasions including resources for sounding a total quantity of antennas using three transmit chains of the UE, where the total quantity of antennas includes at least four antennas. The operations of 1705 may be performed in accordance with aspects as disclosed herein. In some aspects, aspects of the operations of 1705 may be performed by an SRS configuration manager 1225 as described with reference to FIG. 12.

At 1710, the method may include receiving, from the UE, one or more SRSs over a first quantity of one or more antennas of the total quantity of antennas via the three transmit chains during a first sounding occasion in the set of sounding occasions, where the first quantity of one or more antennas is less than the total quantity of antennas. The operations of 1710 may be performed in accordance with aspects as disclosed herein. In some aspects, aspects of the operations of 1710 may be performed by an SRS manager 1230 as described with reference to FIG. 12.

At 1715, the method may include receiving, from the UE, one or more SRSs over a second quantity of one or more antennas of the total quantity of antennas via the three transmit chains during a second sounding occasion in the set of sounding occasions, where the second quantity of one or more antennas is less than the total quantity of antennas, and where the first quantity of one or more antennas and the second quantity of one or more antennas each include a same quantity of antennas that collectively include the at least four antennas. The operations of 1715 may be performed in accordance with aspects as disclosed herein. In some aspects, aspects of the operations of 1715 may be performed by an SRS manager 1230 as described with reference to FIG. 12.

The following provides an overview of aspects of the present disclosure:

Aspect 1: A method of wireless communication performed by a network entity, comprising: receiving an indication of a set of sounding occasions, the set of sounding occasions including resources for sounding a total quantity of antennas using a set of transmit chains of the network entity; transmitting one or more SRSs over a first quantity of one or more antennas of the total quantity of antennas via a first group of the set of transmit chains during a first sounding occasion in the set of sounding occasions, wherein the first quantity of one or more antennas is less than the total quantity of antennas, and wherein the first group is any quantity of the set of transmit chains; and transmitting one or more SRSs over a second quantity of one or more antennas of the total quantity of antennas via a second group of the set of transmit chains during a second sounding occasion in the set of sounding occasions, wherein the second quantity of one or more antennas is less than the total quantity of antennas, and wherein the second group is any quantity of the set of transmit chains, and wherein the first quantity of one or more antennas and the second quantity of one or more antennas are different quantities that collectively include the total quantity of antennas.

Aspect 2: The method of aspect 1, wherein the set of transmit chains includes three transmit chains, and the total quantity of antennas includes at least four antennas.

Aspect 3: The method of aspect 2, wherein the first quantity of one or more antennas excludes the one or more antennas of the second quantity of one or more antennas, and the second quantity of one or more antennas excludes the one or more antennas of the first quantity of one or more antennas.

Aspect 4: The method of aspect 3, wherein the total quantity of antennas is four antennas, and the first quantity of one or more antennas is three of the four antennas and the first group is all of the three transmit chains, and the second quantity of one or more antennas is one of the four antennas and the second group is one of the three transmit chains.

Aspect 5: The method of aspect 4, wherein the first sounding occasion is before the second sounding occasion.

Aspect 6: The method of any of aspects 4 through 5, wherein the second sounding occasion is before the first sounding occasion.

Aspect 7: The method of any of aspects 4 through 6, wherein the resources comprise a four-port SRS configuration for application during transmission of the one or more SRSs via the first group and a one-port SRS configuration for application during transmission of the one or more SRSs via the second group.

Aspect 8: The method of any of aspects 4 through 7, wherein the resources comprise a three-port SRS configuration for application during transmission of the one or more SRSs via the first group and a one-port SRS configuration for application during transmission of the one or more SRSs via the second group.

Aspect 9: The method of any of aspects 3 through 8, further comprising: transmitting one or more SRSs over a third quantity of one or more antennas of the total quantity of antennas via a third group of the three transmit chains during a third sounding occasion in the set of sounding occasions, wherein the third quantity of one or more antennas excludes the one or more antennas of the first quantity of one or more antennas and of the second quantity of one or more antennas, and wherein the third group is any quantity of the three transmit chains.

Aspect 10: The method of aspect 9, wherein the total quantity of antennas is eight antennas, the first quantity of one or more antennas is three of the eight antennas and the first group is all of the three transmit chains, the second quantity of one or more antennas is three of the eight antennas and the second group is all of the three transmit chains, and the third quantity of one or more antennas is two of the eight antennas and the third group is two of the three transmit chains.

Aspect 11: The method of aspect 10, wherein the first sounding occasion and the second sounding occasion are before the third sounding occasion.

Aspect 12: The method of any of aspects 10 through 11, wherein the first sounding occasion is before the third sounding occasion, and the third sounding occasion is before the second sounding occasion.

Aspect 13: The method of any of aspects 10 through 12, wherein the third sounding occasion is before the first sounding occasion and is before the second sounding occasion.

Aspect 14: The method of any of aspects 10 through 13, wherein the resources comprise a four-port SRS configuration for application during transmission of the one or more SRSs via the first group and via the second group and a two-port SRS configuration for application during transmission of the one or more SRSs via the third group.

Aspect 15: The method of any of aspects 10 through 14, wherein the resources comprise a three-port SRS configuration for application during transmission of the one or more SRSs via the first group and via the second group and a two-port SRS configuration for application during transmission of the one or more SRSs via the third group.

Aspect 16: The method of any of aspects 1 through 15, wherein the SRSs transmitted during the first sounding occasion and the second sounding occasion are transmitted at different transmit power levels.

Aspect 17: The method of any of aspects 1 through 16, wherein the network entity comprises a UE.

Aspect 18: The method of any of aspects 1 through 17, wherein a first number of transmit chains in the set of transmit chains is a smaller number than a second number of antennas in the total quantity of antennas.

Aspect 19: A method of wireless communication performed by a network entity, comprising: receiving an indication of a set of sounding occasions, the set of sounding occasions including resources for sounding a total quantity of antennas using three transmit chains of the network entity, wherein the total quantity of antennas includes at least four antennas; transmitting one or more SRSs over a first quantity of one or more antennas of the total quantity of antennas via the three transmit chains during a first sounding occasion in the set of sounding occasions, wherein the first quantity of one or more antennas is less than the total quantity of antennas; and transmitting one or more SRSs over a second quantity of one or more antennas of the total quantity of antennas via the three transmit chains during a second sounding occasion in the set of sounding occasions, wherein the second quantity of one or more antennas is less than all of the total quantity of antennas, and wherein the first quantity of one or more antennas and the second quantity of antennas each include a same quantity of antennas that collectively include the at least four antennas.

Aspect 20: The method of aspect 19, wherein the second quantity of one or more antennas includes at least one antenna from the first quantity of one or more antennas.

Aspect 21: The method of aspect 20, wherein the total quantity of antennas is four antennas, and a quantity of antennas included in each of the first quantity of one or more antennas and the second quantity of one or more antennas is three.

Aspect 22: The method of aspect 21, wherein the first quantity of one or more antennas includes a first antenna, a second antenna, and a third antenna, and the second quantity of one or more antennas includes a fourth antenna, the first antenna, and the second antenna.

Aspect 23: The method of any of aspects 20 through 22, further comprising: transmitting one or more SRSs over a third quantity of one or more antennas of the total quantity of antennas via a third group of the three transmit chains during a third sounding occasion in the set of sounding occasions.

Aspect 24: The method of aspect 23, wherein the total quantity of antennas is eight antennas, and a quantity of antennas included in each of the first quantity of one or more antennas, the second quantity of one or more antennas, and the third quantity of one or more antennas is three, and the first quantity of one or more antennas, the second quantity of one or more antennas, and the third quantity of one or more antennas collectively include all of the eight antennas.

Aspect 25: The method of any of aspects 23 through 24, wherein the first quantity of one or more antennas includes a first antenna, a second antenna, and a third antennas, the second quantity of one or more antennas includes a fourth antenna, a fifth antenna, and a sixth antenna, and the third quantity of one or more antennas includes a seventh antenna, an eighth antenna, and the first antenna.

Aspect 26: The method of any of aspects 20 through 25, wherein the resources comprise a four-port SRS configuration for application during transmission of the one or more SRSs via the three transmit chains.

Aspect 27: The method of any of aspects 20 through 26, wherein the resources comprise a three-port SRS configuration for application during transmission of the one or more SRSs via the three transmit chains.

Aspect 28: The method of any of aspects 20 through 27, further comprising: receiving information identifying an overlap in specific antennas included in each quantity of one or more antennas.

Aspect 29: The method of any of aspects 19 through 28, wherein the network entity comprises a UE.

Aspect 30: A method of wireless communication performed by a network entity, comprising: transmitting, to a UE, an indication of a set of sounding occasions, the set of sounding occasions including resources for sounding a total quantity of antennas using a set of transmit chains of the UE; receiving, from the UE, one or more SRSs over a first quantity of one or more antennas of the total quantity of antennas via a first group of the set of transmit chains during a first sounding occasion in the set of sounding occasions, wherein the first quantity of one or more antennas is less than the total quantity of antennas and the first group is any quantity of the set of transmit chains; and receiving, from the UE, one or more SRSs over a second quantity of one or more antennas of the total quantity of antennas via a second group of the set of transmit chains during a second sounding occasion in the set of sounding occasions, wherein the second quantity of one or more antennas is less than the total quantity of antennas and the second group is any quantity of the set of transmit chains, and wherein the first quantity of one or more antennas and the second quantity of one or more antennas are different quantities that collectively include the total quantity of antennas.

Aspect 31: The method of aspect 30, wherein the set of transmit chains includes three transmit chains, and the total quantity of antennas includes at least four antennas.

Aspect 32: The method of aspect 31, wherein the first quantity of one or more antennas excludes the one or more antennas of the second quantity of one or more antennas, and the second quantity of one or more antennas excludes the one or more antennas of the first quantity of one or more antennas.

Aspect 33: The method of aspect 32, wherein the total quantity of antennas is four antennas, and the first quantity of one or more antennas is three of the four antennas and the first group is all of the three transmit chains, and the second quantity of one or more antennas is one of the four antennas and the second group is one of the three transmit chains.

Aspect 34: The method of aspect 33, wherein the first sounding occasion is before the second sounding occasion.

Aspect 35: The method of any of aspects 33 through 34, wherein the second sounding occasion is before the first sounding occasion.

Aspect 36: The method of any of aspects 33 through 35, wherein the resources comprise a four-port SRS configuration for application during transmission of the one or more SRSs via the first group and a one-port SRS configuration for application during transmission of the one or more SRSs via the second group.

Aspect 37: The method of any of aspects 33 through 36, wherein the resources comprise a three-port SRS configuration for application during transmission of the one or more SRSs via the first group and a one-port SRS configuration for application during transmission of the one or more SRSs via the second group.

Aspect 38: The method of any of aspects 32 through 37, further comprising: receiving, from the UE, one or more SRSs over a third quantity of one or more antennas of the total quantity of antennas via a third group of the three transmit chains during a third sounding occasion in the set of sounding occasions, wherein the third quantity of one or more antennas excludes the one or more antennas of the first quantity of one or more antennas and of the second quantity of one or more antennas, and wherein the third group is any quantity of the three transmit chains.

Aspect 39: The method of aspect 38, wherein the total quantity of antennas is eight antennas, the first quantity of one or more antennas is three of the eight antennas and the first group is all of the three transmit chains, the second quantity of one or more antennas is three of the eight antennas and the second group is all of the three transmit chains, and the third quantity of one or more antennas is two of the eight antennas and the third group is two of the three transmit chains.

Aspect 40: The method of aspect 39, wherein the first sounding occasion and the second sounding occasion are before the third sounding occasion.

Aspect 41: The method of any of aspects 39 through 40, wherein the first sounding occasion is before the third sounding occasion, and the third sounding occasion is before the second sounding occasion.

Aspect 42: The method of any of aspects 39 through 41, wherein the third sounding occasion is before the first sounding occasion and is before the second sounding occasion.

Aspect 43: The method of any of aspects 39 through 42, wherein the resources comprise a four-port SRS configuration for application during transmission of the one or more SRSs via the first group and via the second group and a two-port SRS configuration for application during transmission of the one or more SRSs via the third group.

Aspect 44: The method of any of aspects 39 through 43, wherein the resources comprise a three-port SRS configuration for application during transmission of the one or more SRSs via the first group and via the second group and a two-port SRS configuration for application during transmission of the one or more SRSs via the third group.

Aspect 45: The method of any of aspects 30 through 44, wherein the SRSs transmitted during the first sounding occasion and the second sounding occasion are transmitted by the UE at different transmit power levels.

Aspect 46: The method of any of aspects 30 through 45, wherein a first number of transmit chains in the set of transmit chains is a smaller number than a second number of antennas in the total quantity of antennas.

Aspect 47: A method of wireless communication performed by a network entity, comprising: transmitting, to a UE, an indication of a set of sounding occasions, the set of sounding occasions including resources for sounding a total quantity of antennas using three transmit chains of the UE, wherein the total quantity of antennas includes at least four antennas; receiving, from the UE, one or more SRSs over a first quantity of one or more antennas of the total quantity of antennas via the three transmit chains during a first sounding occasion in the set of sounding occasions, wherein the first quantity of one or more antennas is less than the total quantity of antennas; and receiving, from the UE, one or more SRSs over a second quantity of one or more antennas of the total quantity of antennas via the three transmit chains during a second sounding occasion in the set of sounding occasions, wherein the second quantity of one or more antennas is less than the total quantity of antennas, and wherein the first quantity of one or more antennas and the second quantity of one or more antennas each include a same quantity of antennas that collectively include the at least four antennas.

Aspect 48: The method of aspect 47, wherein the second quantity of one or more antennas includes at least one antennas from the first quantity of one or more antennas.

Aspect 49: The method of aspect 48, wherein the total quantity of antennas includes four antennas, and a quantity of antennas included in each of the first quantity of one or more antennas and the second quantity of one or more antennas t is three.

Aspect 50: The method of aspect 49, wherein the first quantity of one or more antennas includes a first antenna, a second antenna, and a third antenna, and the second quantity of one or more antennas includes a fourth antenna, the first antenna, and the second antenna.

Aspect 51: The method of any of aspects 48 through 50, further comprising: receiving, from the UE, one or more SRSs over a third quantity of one or more antennas of the total quantity of antennas via a third group of the three transmit chains during a third sounding occasion in the set of sounding occasions.

Aspect 52: The method of aspect 51, wherein the total quantity of antennas is eight antennas, and a quantity of antennas included in each of the first quantity of one or more antennas, the second quantity of one or more antennas, and the third quantity of one or more antennas is three, and the first quantity of one or more antennas, the second quantity of one or more antennas, and the third quantity of one or more antennas collectively include all of the eight antennas.

Aspect 53: The method of aspect 52, wherein the first quantity of one or more antennas includes a first antenna, a second antenna, and a third antennas, the second quantity of one or more antennas includes a fourth antenna, a fifth antenna, and a sixth antenna, and the third quantity of one or more antennas includes a seventh antenna, an eighth antenna, and the first antenna.

Aspect 54: The method of any of aspects 48 through 53, wherein the resources comprise a four-port SRS configuration for application during transmission of the one or more SRSs via the three transmit chains.

Aspect 55: The method of any of aspects 48 through 54, wherein the resources comprise a three-port SRS configuration for application during transmission of the one or more SRSs via the three transmit chains.

Aspect 56: The method of any of aspects 48 through 55, further comprising: transmitting, to the UE, information identifying an overlap in specific antennas included in each quantity of one or more antennas.

Aspect 57: A network entity for wireless communication, comprising a processing system configured to perform a method of any of aspects 1 through 18.

Aspect 58: A network entity for wireless communication, comprising at least one means for performing a method of any of aspects 1 through 18.

Aspect 59: A non-transitory computer-readable medium having code for wireless communication stored thereon that, when executed by a network entity, causes the network entity to perform a method of any of aspects 1 through 18.

Aspect 60: A network entity for wireless communication, comprising a processing system configured to perform a method of any of aspects 19 through 29.

Aspect 61: A network entity for wireless communication, comprising at least one means for performing a method of any of aspects 19 through 29.

Aspect 62: A non-transitory computer-readable medium storing code for wireless communication, the code comprising instructions executable by one or more processors to perform a method of any of aspects 19 through 29.

Aspect 63: A network entity for wireless communication, comprising a processing system configured to perform a method of any of aspects 30 through 46.

Aspect 64: A network entity for wireless communication, comprising at least one means for performing a method of any of aspects 30 through 46.

Aspect 65: A non-transitory computer-readable medium having code for wireless communication stored thereon that, when executed by a network entity, causes the network entity to perform a method of any of aspects 30 through 46.

Aspect 66: A network entity for wireless communication, comprising a processing system configured to perform a method of any of aspects 47 through 56.

Aspect 67: A network entity for wireless communication, comprising at least one means for performing a method of any of aspects 47 through 56.

Aspect 68: A non-transitory computer-readable medium having code for wireless communication stored thereon that, when executed by a network entity, causes the network entity to perform a method of any of aspects 47 through 56.

The methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other aspects and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the aspects that may be implemented or that are within the scope of the claims. The term “aspect” or “example” used herein means “serving as an example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described aspects.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the aspects and designs described herein but is to be accorded the broadest scope consistent with the principles and novel features disclosed herein.

What is claimed is:

1. A network entity for wireless communication, comprising:
a processing system configured to:
receive an indication of a set of sounding occasions, the set of sounding occasions including resources for sounding a total quantity of antennas using a set of transmit chains of the network entity;
transmit one or more sounding reference signals (SRSs) over a first quantity of one or more antennas of the total quantity of antennas via a first group of the set of transmit chains during a first sounding occasion in the set of sounding occasions, wherein the first quantity of one or more antennas is less than the total quantity of antennas, and wherein the first group is any quantity of the set of transmit chains; and
transmit one or more SRSs over a second quantity of one or more antennas of the total quantity of antennas via a second group of the set of transmit chains during a second sounding occasion in the set of sounding occasions, wherein the second quantity of one or more antennas is less than the total quantity of antennas, and wherein the second group is any quantity of the set of transmit chains, wherein the first quantity of one or more antennas and the second quantity of one or more antennas are different quantities that collectively include the total quantity of antennas.

2. The network entity of claim 1, wherein the set of transmit chains includes three transmit chains, and wherein the total quantity of antennas includes at least four antennas.

3. The network entity of claim 2, wherein the first quantity of one or more antennas excludes the one or more antennas of the second quantity of one or more antennas, and the second quantity of one or more antennas excludes the one or more antennas of the first quantity of one or more antennas.

4. The network entity of claim 3, wherein:
the total quantity of antennas is four antennas,
the first quantity of one or more antennas is three of the four antennas and the first group is all of the three transmit chains, and
the second quantity of one or more antennas is one of the four antennas and the second group is one of the three transmit chains.

5. The network entity of claim 1, wherein the first sounding occasion is before the second sounding occasion.

6. The network entity of claim 1, wherein the second sounding occasion is before the first sounding occasion.

7. The network entity of claim 1, wherein the resources comprise a four-port SRS configuration for application during transmission of the one or more SRSs via the first group and a one-port SRS configuration for application during transmission of the one or more SRSs via the second group.

8. The network entity of claim 1, wherein the resources comprise a three-port SRS configuration for application during transmission of the one or more SRSs via the first group and a one-port SRS configuration for application during transmission of the one or more SRSs via the second group.

9. The network entity of claim 1, wherein the processing system is configured to transmit one or more SRSs over a third quantity of one or more antennas of the total quantity of antennas via a third group of the set of transmit chains during a third sounding occasion in the set of sounding occasions, wherein the third quantity of one or more antennas excludes the one or more antennas of the first quantity of one or more antennas and of the second quantity of one or more antennas, and wherein the third group is any quantity of the set of transmit chains.

10. The network entity of claim 9, wherein the resources comprise a four-port SRS configuration for application during transmission of the one or more SRSs via the first group and a two-port SRS configuration for application during transmission of the one or more SRSs via the second group and the third group.

11. The network entity of claim 9, wherein the resources comprise a three-port SRS configuration for application during transmission of the one or more SRSs via the first group and via the second group and a two-port SRS configuration for application during transmission of the one or more SRSs via the third group.

12. The network entity of claim 1, wherein the SRSs transmitted during the first sounding occasion and the second sounding occasion are transmitted at different transmit power levels.

13. The network entity of claim 1, wherein the network entity comprises a user equipment (UE).

14. The network entity of claim 1, wherein a first number of transmit chains in the set of transmit chains is a smaller number than a second number of antennas in the total quantity of antennas.

15. A network entity for wireless communication, comprising:
a processing system configured to:
receive an indication of a set of sounding occasions, the set of sounding occasions including resources for sounding a total quantity of antennas using three transmit chains of the network entity, wherein the total quantity of antennas includes at least four antennas;
transmit one or more sounding reference signals (SRSs) over a first quantity of one or more antennas of the total quantity of antennas via the three transmit chains during a first sounding occasion in the set of sounding occasions, wherein the first quantity of one or more antennas is less than the total quantity of antennas; and
transmit one or more SRSs over a second quantity of one or more antennas of the total quantity of antennas via the three transmit chains during a second sounding occasion in the set of sounding occasions, wherein the second quantity of one or more antennas is less than all of the total quantity of antennas, and wherein the first quantity of one or more antennas and the second quantity of antennas each include a same quantity of antennas that collectively include the at least four antennas.

16. The network entity of claim 15, wherein the second quantity of one or more antennas includes at least one antenna from the first quantity of one or more antennas.

17. The network entity of claim 16, wherein:
the total quantity of antennas is four antennas, and
a quantity of antennas included in each of the first quantity of one or more antennas and the second quantity of one or more antennas is three.

18. The network entity of claim 16, wherein:
the first quantity of one or more antennas includes a first antenna, a second antenna, and a third antenna, and
the second quantity of one or more antennas includes a fourth antenna, the first antenna, and the second antenna.

19. The network entity of claim 16, wherein the processing system is configured to transmit one or more SRSs over a third quantity of one or more antennas of the total quantity of antennas via a third group of the three transmit chains during a third sounding occasion in the set of sounding occasions.

20. The network entity of claim 15, wherein the resources comprise a four-port SRS configuration for application during transmission of the one or more SRSs via the three transmit chains.

21. The network entity of claim 15, wherein the resources comprise a three-port SRS configuration for application during transmission of the one or more SRSs via the three transmit chains.
